(19) United States
(12) Patent Application Publication
(10) Pub. No.: US 2025/0164749 A1
(43) Pub. Date: May 22, 2025

(54) CAMERA OPTICAL LENS

(71) Applicant: AAC OPTICS (CHANGZHOU) CO., LTD., Changzhou (CN)

(72) Inventors: Tao Zhang, Changzhou (CN); Shunda Zhou, Changzhou (CN)

(21) Appl. No.: 18/736,542

(22) Filed: Jun. 7, 2024

(30) Foreign Application Priority Data
Nov. 21, 2023 (CN) 202311563897.4

(51) Int. Cl. G02B 13/00; G02B 9/62

(52) U.S. Cl. CPC G02B 13/0045; G02B 9/62; G02B 13/0055

(57) ABSTRACT

The present disclosure relates to the field of optical lens, and discloses a camera optical lens. The camera optical lens includes: from an object side to an image side, a first lens having positive refractive power, a second lens having negative refractive power, a third lens having negative refractive power, a fourth lens having refractive power, a fifth lens having positive refractive power, and a sixth lens having negative refractive power, and following relational expressions are satisfied: 0.10≤d8/TTL≤0.20; −5.00≤R9/R10≤−0.80; and 0.70≤f2/f3≤1.00.

### TECHNICAL FIELD

The present disclosure relates to the field of optical lens and, in particular, to a camera optical lens applicable to handheld terminal devices such as smart phones, digital cameras, and camera devices such as monitors, PC lenses, vehicle-mounted lenses, and unmanned aerial vehicle.

### BACKGROUND

In recent years, with the rise of various smart devices, the demand for a miniaturized camera optical lens has gradually increased, and since the pixel size of the optical sensor is reduced, and the current electronic product has a development trend of light weight, thin and portable, the miniaturized camera optical lens with good imaging quality has become the mainstream of the current market. In order to obtain better imaging quality, a multi-lens structure is mostly used. In addition, with the development of technology and the increase of diversified requirements of users, under the condition that the pixel area of the photosensitive device is continuously reduced and the requirements on the imaging quality of the system are continuously improved, the structure with six lenses gradually appears in the lens design. There is an urgent need for a camera optical lens having excellent optical performance, large aperture and is ultra-thin.

### SUMMARY

In view of the above problems, an object of the present disclosure is to provide a camera optical lens, which has excellent optical performance and meets design requirements of large-aperture and ultra-thinness.

In order to solve the above technical problem, the present disclosure provides a camera optical lens. The camera optical lens includes: from an object side to an image side, a first lens having positive refractive power, a second lens having negative refractive power, a third lens having negative refractive power, a fourth lens having positive or negative refractive power, and a fifth lens having positive refractive power, and a sixth lens having negative refractive power. A focal length of the second lens is defined as f2, a focal length of the third lens is defined as f3, an on-axis distance from an image side surface of the fourth lens to an object side surface of the fifth lens is defined as d8, a central curvature radius of the object side surface of the fifth lens is defined as R9, a central curvature radius of an image side surface of the fifth lens is defined as R10, a total optical length from an object side surface of the first lens to an image plane of the camera optical lens along an optic axis of the camera optical lens is defined as TTL, and following relational expressions are satisfied:

$$0.1 ⩽ d 8 / TTL ⩽ 0.2 ;$$

$$and$$

$$- 5. ⩽ R 9 / R 10 ⩽ - 0.8 ;$$

$$0.7 ⩽ f 2 / f 3 ⩽ 1. .$$

As an improvement, a central curvature radius of an object side surface of the sixth lens is defined as R11, a central curvature radius of an image side surface of the sixth lens is defined as R12, and a following relational expression is satisfied:

$$0 \text{.16} ⩽ R 11 / R 12 ⩽ 0.6 4 .$$

As an improvement, a focal length of the camera optical lens is defined as f, a focal length of the first lens is defined as f1, and a following relational expression is satisfied:

$$0.4 ⩽ f 1 / f ⩽ 0.5 0 .$$

As an improvement, an on-axis distance from an image side surface of the third lens to an object side surface of the fourth lens is defined as d6, an on-axis thickness of the fourth lens is defined as d7, and a following relational expression is satisfied:

$$2. ⩽ d 6 / d 7 ⩽ 4. 0 .$$

As an improvement, an object side surface of the first lens is convex in a paraxial region, and an image side surface of the first lens is convex in the paraxial region;
a central curvature radius of the object side surface of the first lens is defined as R1, a central curvature radius of the image side surface of the first lens is defined as R2, an on-axis thickness of the first lens is defined as d1, and following relational expressions are satisfied:

$$- 1.25 ⩽ ( R 1 + R 2 ) / ( R 1 - R 2 ) ⩽ - 0.32 ;$$

$$and$$

$$0.1 ⩽ d 1 / TTL ⩽ 0.3 4 .$$

As an improvement, an object side surface of the second lens is concave in a paraxial region, and an image side surface of the second lens is concave in the paraxial region;
a focal length of the camera optical lens is defined as f, a central curvature radius of the object side surface of the second lens is defined as R3, a central curvature radius of the image side surface of the second lens is defined as R4, an on-axis thickness of the second lens is defined as d3, and following relational expressions are satisfied:

$$- 2.25 ⩽ f 2 / f ⩽ - 0.61 ; \\ 0.38 ⩽ ( R 3 + R 4 ) / ( R 3 - R 4 ) ⩽ 1.37 ; and \\ 0.01 ⩽ d 3 / TTL ⩽ 0.06 .$$

As an improvement, an object side surface of the third lens is convex in a paraxial region, and an image side surface of the third lens is concave in the paraxial region;
a focal length of the camera optical lens is defined as f, a central curvature radius of the object side surface of the third lens is defined as R5, a central curvature radius of the image side surface of the third lens is defined as R6, an on-axis thickness of the third lens is defined as d5, and following relational expressions are satisfied:

$$- 3.15 ⩽ f 3 / f ⩽ - 0.62 ; \\ 1.04 ⩽ ( R 5 + R 6 ) / ( R 5 - R 6 ) ⩽ 4.75 ; and \\ 0.02 ⩽ d 5 / TTL ⩽ 0.07 .$$

As an improvement, a focal length of the camera optical lens is f, a focal length of the fourth lens is defined as f4, a central curvature radius of the object side surface of the fourth lens is defined as R7, a central curvature radius of the image side surface of the fourth lens is defined as R8, an on-axis thickness of the fourth lens is defined as d7, and following relational expressions are satisfied:

$$- 34.78 ⩽ f 4 / f ⩽ 28.49 ; \\ - 5.49 ⩽ ( R 7 + R 8 ) / ( R 7 - R 8 ) ⩽ 1.62 ; and \\ 0.02 ⩽ d 7 / TTL ⩽ 0.07 .$$

As an improvement, the object side surface of the fifth lens is convex in a paraxial region, the image side surface of the fifth lens is convex in the paraxial region;
a focal length of the camera optical lens is defined as f, a focal length of the fifth lens is f5, an on-axis thickness of the fifth lens is defined as d9, and following relational expressions are satisfied:

$$0.95 ⩽ f 5 / f ⩽ 3.59 ; \\ - 0.22 ⩽ ( R 9 + R 10 ) / ( R 9 - R 10 ) ⩽ 1. ; and \\ 0.04 ⩽ d 9 / TTL ⩽ 0.15 .$$

As an improvement, an object side surface of the sixth lens is concave in a paraxial region, and an image side surface of the sixth lens is convex in the paraxial region;
a focal length of the camera optical lens is f, a focal length of the sixth lens is defined as f6, a central curvature radius of the object side surface of the sixth lens is defined as R11, a central curvature radius of the image side surface of the sixth lens is defined as R12, an on-axis thickness of the sixth lens is defined as d11, and following relational expressions are satisfied:

$$- 4.17 ⩽ f 6 / f ⩽ - 0.6 ; \\ - 9.09 ⩽ ( R 11 + R 12 ) / ( R 11 - R 12 ) ⩽ - 0.92 ; and \\ 0.02 ⩽ d 11 / TTL ⩽ 0.15 .$$

The present disclosure has following beneficial effects: the camera optical lens as described in the present disclosure has excellent optical characteristics of large aperture and ultra-thinness, and is particularly suitable for a mobile phone camera lens assembly, a vehicle-mounted lens and a WEB camera lens composed of camera elements such as CCD, CMOS with high resolution.

### BRIEF DESCRIPTION OF DRAWINGS

Many aspects of the exemplary embodiment can be better understood with reference to following drawings. The components in the drawings are not necessarily drawn to scale, the emphasis instead being placed upon clearly illustrating the principles of the present disclosure. Moreover, in the drawings, like reference numerals designate corresponding parts throughout the several views

FIG. 1 is a structural schematic diagram of a camera optical lens according to Embodiment 1 of the present disclosure;

FIG. 2 is a schematic diagram of longitudinal aberration of the camera optical lens shown in FIG. 1;

FIG. 3 is a schematic diagram of lateral color of the camera optical lens shown in FIG. 1;

FIG. 4 is a schematic diagram of field curvature and distortion of the camera optical lens shown in FIG. 1;

FIG. 5 is a structural schematic diagram of a camera optical lens according to Embodiment 2 of the present disclosure;

FIG. 6 is a schematic diagram of longitudinal aberration of the camera optical lens shown in FIG. 5;

FIG. 7 is a schematic diagram of lateral color of the camera optical lens shown in FIG. 5;

FIG. 8 is a schematic diagram of field curvature and distortion of the camera optical lens shown in FIG. 5;

FIG. 9 is a structural schematic diagram of a camera optical lens according to Embodiment 3 of the present disclosure;

FIG. 10 is a schematic diagram of longitudinal aberration of the camera optical lens shown in FIG. 9;

FIG. 11 is a schematic diagram of lateral color of the camera optical lens shown in FIG. 9;

FIG. 12 is a schematic diagram of field curvature and distortion of the camera optical lens shown in FIG. 9;

FIG. 13 is a structural schematic diagram of a camera optical lens according to Embodiment 4 of the present disclosure;

FIG. 14 is a schematic diagram of longitudinal aberration of the camera optical lens shown in FIG. 13;

FIG. 15 is a schematic diagram of lateral color of the camera optical lens shown in FIG. 13;

FIG. 16 is a schematic diagram of field curvature and distortion of the camera optical lens shown in FIG. 13;

FIG. 17 is a structural schematic diagram of a camera optical lens according to Embodiment 5 of the present disclosure;

FIG. 18 is a schematic diagram of longitudinal aberration of the camera optical lens shown in FIG. 17;

FIG. 19 is a schematic diagram of lateral color of the camera optical lens shown in FIG. 17;

FIG. 20 is a schematic diagram of field curvature and distortion of the camera optical lens shown in FIG. 17;

FIG. 21 is a schematic structural diagram of a camera optical lens according to Comparative Embodiment;

FIG. 22 is a schematic diagram of longitudinal aberration of the camera optical lens shown in FIG. 21;

FIG. 23 is a schematic diagram of lateral color of the camera optical lens shown in FIG. 21; and

FIG. 24 is a schematic diagram of field curvature and distortion of the camera optical lens shown in FIG. 21.

### DESCRIPTION OF EMBODIMENTS

In order to more clearly illustrate objectives, technical solutions, and advantages of Embodiments of the present disclosure, the technical solutions in Embodiments of the present disclosure are clearly and completely described in details with reference to the accompanying drawings. The described embodiments are merely part of the embodiments of the present disclosure rather than all of the embodiments. All other embodiments obtained by those skilled in the art based on the embodiments of the present disclosure shall fall into the protection scope of the present disclosure.

### Embodiment 1

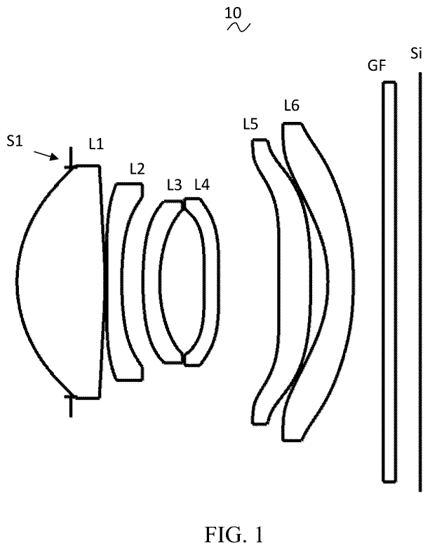

Referring to the drawings, the present disclosure provides a camera optical lens 10. FIG. 1 shows a camera optical lens 10 according to Embodiment 1 of the present disclosure. The camera optical lens 10 includes six lenses. The camera optical lens 10 sequentially includes: from an object side to an image side, a first lens L1, an aperture S1, a second lens L2, a third lens L3, a fourth lens L4, a fifth lens L5, and a sixth lens L6. An optical element such as a optical filter GF may be provided between the sixth lens L6 and the image plane Si.

In this embodiment, the first lens L1, the second lens L2, the third lens L3, the fourth lens L4, the fifth lens L5, and the sixth lens L6 are all made of glass. In other alternative embodiments, the lenses may be made of other materials.

An on-axis distance from an image side surface of the fourth lens L4 to an object side surface of the fifth lens L5 is defined as d8, a total optical length from an object side surface of the first lens to an image plane of the camera optical lens along an optic axis of the camera optical lens 10 is defined as TTL, and a following relational expression is satisfied: 0.10≤d8/TTL≤0.20, which specifies a ratio of an air gap between the fourth lens L4 and the fifth lens L5 to TTL. Within the range of the relational expression, it is beneficial to achieving long focal imaging by the air gap is reasonably distributed.

A central curvature radius of the object side surface of the fifth lens L5 is defined as R9, an central curvature radius of an image side surface of the fifth lens L5 is defined as R10, and a following relational expression is satisfied: −5.00≤R9/R10≤−0.80, which specifies a shape of the fifth lens L5, within the range of the relational expression, the deflection degree of light passing through the lens may be alleviated, the chromatic aberration is effectively corrected, so that the chromatic aberration |LC|≤3.0 μm.

A focal length of the second lens L2 is defined as f2, a focal length of the third lens L3 is defined as f3, and a following relational expression is satisfied: 0.70≤f2/f3≤1.00, which specifies a ratio of the focal length of the second lens L2 to the focal length of the third lens L3. Within the range of the relational expression, by reasonably distributing the optical focal length of the system, the system has better imaging quality and lower sensitivity.

A central curvature radius of an object side surface of the sixth lens L6 is defined as R11, a central curvature radius of an image side surface of the sixth lens L6 is defined as R12, following relational expression is satisfied: 0.16≤R11/R12≤0.64, which specifies a shape of the sixth lens L6. Within the range of the relational expression, it is beneficial to correcting astigmatism and distortion of the camera lens, so that |Distortion|2%, and the possibility of vignetting is reduced.

A focal length of the camera optical lens 10 is defined as f, a focal length of the first lens L1 is defined as f1, and a following relational expression is satisfied: 0.40≤f1/f≤0.50, which specifies a ratio of the first lens L1 to a focal length of the system. Within the range of the relational expression, by reasonably distributing the focal length of the system, it is helpful for light entering, ensuring the amount of light transmitted.

An on-axis distance from an image side surface of the third lens L3 to an object side surface of the fourth lens L4 is defined as d6, an on-axis thickness of the fourth lens L4 is defined as d7, and a following relational expression is satisfied: 2.00≤d6/d7≤4.00, which specifies a ratio of the air gap between the third lens L3 and the fourth lens L4 to an on-axis thickness of the fourth lens L4. Within the range of the relational expression, it helps to compress a total length of the optical system.

An object side surface of the first lens L1 is convex in a paraxial region, an image side surface of the first lens L1 is convex in the paraxial region, and the first lens L1 has positive refractive power. In other optional embodiments, the object side surface and the image side surface of the first lens L1 may be provided with other concave and convex distributions.

A central curvature radius of the object side surface of the first lens L1 is defined as R1, a central curvature radius of the image side surface of the first lens L1 is defined as R2, and a following relational expression is satisfied: −1.25≤(R1+R2)/(R1−R2)≤−0.32. The shape of the first lens L1 is reasonably controlled, so that the first lens L1 may effectively correct the spherical aberration of the system. Optionally, −0.78≤(R1+R2)/(R1−R2)≤−0.40 is satisfied.

An on-axis thickness of the first lens L1 is d1, the total optical length from the object side surface of the first lens to an image plane of the camera optical lens along an optic axis of the camera optical lens 10 is TTL, and a following relational expression is satisfied: 0.10≤d1/TTL≤0.34. Within the range of the relational expression, it is beneficial to achieving miniaturization. Optionally, 0.17≤d1/TTL≤0.27 is satisfied.

An object side surface of the second lens L2 is concave in the paraxial region, an image side surface of the second lens L2 is concave in the paraxial region, and the second lens L2 has negative refractive power. In other optional embodiments, the object side surface and the image side surface of the second lens L2 may be provided with other concave and convex distributions.

The focal length of the camera optical lens 10 is defined as f, the focal length of the second lens L2 is defined as f2, and a following relational expression is satisfied: −2.25≤f2/f≤−0.61, it is beneficial to correcting the aberration of the optical system by the negative refractive power of the second lens L2 is controlled in a reasonable range. Optionally, −1.41≤f2/f≤−0.76 is satisfied.

A central curvature radius of the object side surface of the second lens L2 is R3, a central curvature radius of the image side surface of the second lens L2 is R4, and a following relational expression is satisfied: 0.38≤(R3+R4)/(R3−R4)≤1.37, which specifies a shape of the second lens L2. Within the range of the relational expression, it is beneficial to correcting the problems such as the aberration of off-axis angle with the development of the ultra-thinness and wide-angle. Optionally, 0.61≤(R3+R4)/(R3−R4)≤1.10 is satisfied.

An on-axis thickness of the second lens L2 is d3, the total optical length from the object side surface of the first lens to an image plane of the camera optical lens along an optic axis of the camera optical lens 10 is TTL, and a following relational expression is satisfied: 0.01≤d3/TTL≤0.06. Within the range of the relational expression, it is beneficial to achieving miniaturization. Optionally, 0.02≤d3/TTL≤0.05 is satisfied.

An object side surface of the third lens L3 is convex in the paraxial region, an image side surface of the third lens L3 is concave in the paraxial region, and the third lens L3 has negative refractive power. In other optional embodiments, the object side surface and the image side surface of the third lens L3 may be provided with other concave and convex distributions.

The focal length of the camera optical lens 10 is defined as f, a focal length of the third lens L3 is defined as f3, and a following relational expression is satisfied: −3.15≤f3/f≤−0.62, the system has better imaging quality and lower sensitivity by reasonable distribution of refractive power. Optionally, −1.97≤f3/f≤−0.78 is satisfied.

A central curvature radius of the object side surface of the third lens L3 is R5, a central curvature radius of the image side surface of the third lens L3 is R6, and a following relational expression is satisfied: 1.04≤(R5+R6)/(R5−R6)≤4.75, which specifies a shape of the third lens L3. Within the range of the relational expression, it is beneficial to correcting the problems such as the aberration of off-axis angle with the development of ultra-thinness and wide-angle. Optionally, 1.67≤(R5+R6)/(R5−R6)≤3.80 is satisfied.

An on-axis thickness of the third lens L3 is d5, the total optical length from the object side surface of the first lens to an image plane of the camera optical lens along an optic axis of the camera optical lens 10 is TTL, and a following relational expression is satisfied: 0.02≤d5/TTL≤0.07. Within the range of the relational expression, it is beneficial to achieving miniaturization. Optionally, 0.03≤d5/TTL≤0.06 is satisfied.

In the embodiment, the object side surface of the fourth lens L4 is convex or concave in the paraxial region, the image side surface of the fourth lens L4 is concave or convex in the paraxial region, and the fourth lens L4 has positive refractive power or negative refractive power.

The focal length of the camera optical lens 10 is defined as f, a focal length of the fourth lens L4 is defined as f4, and a following relational expression is satisfied: −34.78≤f4/f≤28.49, the system has better imaging quality and lower sensitivity by reasonable distribution of refractive power. Optionally, −21.74≤f4/f≤22.79 is satisfied.

A central curvature radius of the object side surface of the fourth lens L4 is R7, a central curvature radius of the image side surface of the fourth lens L4 is R8, and a following relational expression is satisfied: −5.49≤(R7+R8)/(R7−R8)≤1.62, which specifies a shape of the fourth lens L4. Within the range of the relational expression, it is beneficial to correcting the problems such as the aberration of off-axis angles with the development of the ultra-thin wide-angle. Optionally, −3.43≤(R7+R8)/(R7−R8)≤1.30 is satisfied.

An on-axis thickness of the fourth lens L4 is d7, the total optical length from the object side surface of the first lens to an image plane of the camera optical lens along an optic axis of the camera optical lens 10 is TTL, and a following relational expression is satisfied: 0.02≤d7/TTL≤0.07. Within the range of the relational expression, it is beneficial to achieving miniaturization. Optionally, 0.02≤d7/TTL≤0.06 is satisfied.

In the embodiment, the object side surface of the fifth lens L5 is convex in the paraxial region, the image side surface of the fifth lens L5 is convex in the paraxial region, and the fifth lens L5 has positive refractive power. In other optional embodiments, the object side surface and the image side surface of the fifth lens L5 may be provided with other concave and convex distributions.

The focal length of the camera optical lens 10 is defined as f, a focal length of the fifth lens L5 is defined as f5, and a following relational expression is satisfied: 0.95≤f5/f≤3.59, the system has better imaging quality and lower sensitivity by reasonable distribution of refractive power. Optionally, 1.53≤f5/f≤2.87 is satisfied.

A central curvature radius of the object side surface of the fifth lens L5 is R9, a central curvature radius of the image side surface of the fifth lens L5 is R10, and a following relational expression is satisfied: −0.22≤(R9+R10)/(R9−R10)≤1.00, which specifies a shape of the fifth lens L5. Within the range of the relational expression, it is beneficial to correcting the problems such as the aberration of off-axis angles with the development of the ultra-thin wide-angle. Optionally, −0.14≤(R9+R10)/(R9−R10)≤0.80 is satisfied.

An on-axis thickness of the fifth lens L5 is d9, the total optical length from the object side surface of the first lens to an image plane of the camera optical lens along an optic axis of the camera optical lens 10 is TTL, and a following relational expression is satisfied: 0.04≤d9/TTL≤0.15. Within the range of the relational expression, it is beneficial to achieving miniaturization. Optionally, 0.06≤d9/TTL≤0.12 is satisfied.

In the embodiment, the object side surface of the sixth lens L6 is concave in the paraxial region, the image side surface of the sixth lens L6 is convex in the paraxial region, and the sixth lens L6 has negative refractive power. In other optional embodiments, the object side surface and the image side surface of the sixth lens L6 may be provided with other concave and convex distributions.

The focal length of the camera optical lens 10 is defined as f, a focal length of the sixth lens L6 is defined as f6, and a following relational expression is satisfied: −4.17≤f6/f≤−0.60, the system has better imaging quality and lower sensitivity by reasonable distribution of refractive power. Optionally, −2.61≤f6/f≤−0.76 is satisfied.

A central curvature radius of the object side surface of the sixth lens L6 is R11, a central curvature radius of the image side surface of the sixth lens L6 is R12, and a following relational expression is satisfied: −9.09≤(R11+R12)/(R11−R12)≤−0.92, which specifies a shape of the sixth lens L6. Within the range of the relational expression, it is beneficial to correcting the problems such as the aberration of off-axis angles with the development of the ultra-thin wide-angle. Optionally, −5.68≤(R11+R12)/(R11−R12)≤−1.15 is satisfied.

An on-axis thickness of the sixth lens L6 is d11, the total optical length from the object side surface of the first lens to an image plane of the camera optical lens along an optic axis of the camera optical lens 10 is TTL, and a following relational expression is satisfied: 0.02≤d11/TTL≤0.15. Within the range of the relational expression, it is beneficial to achieving miniaturization. Optionally, 0.03≤d11/TTL≤0.12 is satisfied.

An image height of the camera optical lens 10 is IH, the total optical length from the object side surface of the first lens to an image plane of the camera optical lens along an optic axis of the camera optical lens 10 is TTL, and a following relational expression is satisfied: TTL/IH≤2.15, it is beneficial to achieving miniaturization.

An F-number FNO of the camera optical lens 10 is smaller than or equal to 1.90, which may achieve large-aperture and good imaging performance.

The camera optical lens 10 has excellent optical performance and can meet the design requirements of large-aperture and ultra-thinness; according to the characteristics, the camera optical lens 10 is particularly suitable for a mobile phone camera lens assembly and a WEB camera lens which are composed of camera elements such as CCD and CMOS with high resolution.

The camera optical lens 10 of the present disclosure will be described below by way of example. The reference signs recited in each example are shown below. The units of the focal length, the on-axis distance, the central curvature radius, the on-axis thickness, the inflection point position, and the arrest point position are mm.

TTL denotes a total optical length from the object side surface of the first lens to an image plane of the camera optical lens along an optic axis (the on-axis distance from the object-side surface of the first lens L1 to the image plane Si), and its unit is mm.

F-number FNO refers to a ratio of the effective focal length of the camera optical lens to the entrance pupil diameter of the camera optical lens.

Optionally, the object side surface and/or the image side surface of the lens may be further provided with an inflection point and/or an arrest point, so as to meet high-quality imaging requirements. The specific embodiments are described below.

Table 1 and Table 2 show design data of the camera optical lens 10 according to Embodiment 1 of the present disclosure.

TABLE 1

| | R | d | | nd | | νd | |
|---|---|---|---|---|---|---|---|
| S1 | ∞ | d0= | −0.905 | | | | |
| R1 | 2.111 | d1= | 1.471 | nd1 | 1.5444 | ν1 | 55.82 |
| R2 | −7.716 | d2= | 0.032 | | | | |
| R3 | −97.510 | d3= | 0.250 | nd2 | 1.6700 | ν2 | 19.39 |
| R4 | 5.242 | d4= | 0.357 | | | | |
| R5 | 5.127 | d5= | 0.280 | nd3 | 1.5444 | ν3 | 55.82 |
| R6 | 2.391 | d6= | 0.746 | | | | |
| R7 | −43.679 | d7= | 0.242 | nd4 | 1.6610 | ν4 | 20.53 |
| R8 | −93.712 | d8= | 1.003 | | | | |
| R9 | 22.866 | d9= | 0.537 | nd5 | 1.6610 | ν5 | 20.53 |
| R10 | −14.695 | d10= | 0.287 | | | | |
| R11 | −2.634 | d11= | 0.425 | nd6 | 1.5346 | ν6 | 55.69 |
| R12 | −7.136 | d12= | 0.500 | | | | |
| R13 | ∞ | d13= | 0.210 | ndg | 1.5168 | νg | 64.17 |
| R14 | ∞ | d14= | 0.407 | | | | |

The meaning of each reference sign is as follows.
S1: aperture;
R: curvature radius at the center of the optical surface;
R1: central curvature radius of the object side surface of the first lens L1;
R2: central curvature radius of the image side surface of the first lens L1;
R3: central curvature radius of the object side surface of the second lens L2;
R4: central curvature radius of the image side surface of the second lens L2;
R5: central curvature radius of the object side surface of the third lens L3;
R6: central curvature radius of the image side surface of the third lens L3;
R7: central curvature radius of the object side surface of the fourth lens L4;
R8: central curvature radius of the image side surface of the fourth lens L4;
R9: central curvature radius of the object side surface of the fifth lens L5;
R10: central curvature radius of the image side surface of the fifth lens L5;
R11: central curvature radius of the object side surface of the sixth lens L6;
R12: central curvature radius of the image side surface of the sixth lens L6;
R13: central curvature radius of the object side surface of the optical filter GF;
R14: central curvature radius of the image side surface of the optical filter GF;
d: on-axis thickness of lenses, on-axis distance between lenses;
d0: on-axis distance from the aperture S1 to the object side surface of the first lens L1;
d1: on-axis thickness of the first lens L1;
d2: on-axis distance from the image side surface of the first lens L1 to the object side surface of the second lens L2;
d3: on-axis thickness of the second lens L2;
d4: on-axis distance from the image side surface of the second lens L2 to the object side surface of the third lens L3;
d5: on-axis thickness of the third lens L3;
d6: on-axis distance from the image side surface of the third lens L3 to the object side surface of the fourth lens L4;
d7: on-axis thickness of the fourth lens L4;
d8: on-axis distance from the image side surface of the fourth lens L4 to the object side surface of the fifth lens L5;
d9: on-axis thickness of the fifth lens L5;
d10: on-axis distance from the image side surface of the fifth lens L5 to the object side surface of the sixth lens L6;
d11: on-axis thickness of the sixth lens L6;
d12: on-axis distance from the image side surface of the sixth lens L6 to the object side surface of the optical filter GF;
d13: on-axis thickness of the optical filter GF;
d14: on-axis distance from the image side surface of the optical filter GF to the image plane Si;
nd: refractive index of d line (the d line corresponds to green light with a wavelength of 550 nm);
nd1: refractive index of d line of the first lens L1;
nd2: refractive index of d line of the second lens L2;
nd3: refractive index of d line of the third lens L3;
nd4: refractive index of d line of the fourth lens L4;
nd5: a refractive index of d line of the fifth lens L5;
nd6: refractive index of d line of the sixth lens L6;
ndg: refractive index of d line of the optical filter GF;
vd: abbe number;
v1: abbe number of the first lens L1;
v2: abbe number of the second lens L2;
v3: abbe number of the third lens L3;
v4: abbe number of the fourth lens L4;
v5: abbe number of the fifth lens L5;
v6: abbe number of the sixth lens L6;
vg: abbe number of the optical filter GF.

Table 2 shows aspheric surface data of each lens in the camera optical lens 10 according to Embodiment 1 of the present disclosure.

TABLE 2

| | |
|---|---|
| Conic Coefficient | Aspheric Coefficient |

| | k | A4 | A6 | A8 | A10 | A12 |
|---|---|---|---|---|---|---|
| R1 | −3.71196E−01 | −1.48452E−03 | 8.46375E−03 | −1.04599E−02 | 8.40955E−03 | −4.57341E−03 |
| R2 | −5.22015E+01 | 7.73367E−03 | 1.46151E−02 | −1.95859E−02 | 1.07107E−02 | −2.51051E−03 |
| R3 | −5.09060E+02 | −1.07962E−02 | 1.17244E−01 | −2.19285E−01 | 2.75188E−01 | −2.30668E−01 |
| R4 | 1.27404E+01 | −4.76109E−02 | 2.70681E−01 | −6.73803E−01 | 1.09316E+00 | −1.08272E+00 |
| R5 | −5.50135E+00 | −5.96138E−02 | 1.29102E+00 | −1.06783E+01 | 5.72771E+01 | −2.04008E+02 |
| R6 | −3.01722E−02 | −7.79463E−02 | 1.17778E+00 | −1.15418E+01 | 7.74995E+01 | −3.45156E+02 |
| R7 | 9.99000E+02 | 1.56605E−01 | −3.98528E+00 | 3.08338E+01 | −1.45904E+02 | 4.51706E+02 |
| R8 | 9.95509E+02 | 1.18671E−01 | −2.59558E+00 | 1.68694E+01 | −6.91505E+01 | 1.92408E+02 |
| R9 | −3.00354E+01 | −3.13774E−02 | −3.47090E−02 | 1.61483E−01 | −3.64469E−01 | 5.01804E−01 |
| R10 | −1.73376E+02 | −5.30890E−02 | −2.78929E−02 | 1.75476E−01 | −3.17526E−01 | 3.37047E−01 |
| R11 | −3.21295E−03 | −7.97572E−02 | 1.71690E−02 | 1.73649E−01 | −2.91603E−01 | 2.49927E−01 |
| R12 | 1.81538E+00 | −6.48214E−02 | 2.95758E−02 | 2.66785E−02 | −5.40333E−02 | 4.49455E−02 |

| | Conic Coefficient | Aspheric Coefficient | | | | |
|---|---|---|---|---|---|---|
| | k | A14 | A16 | A18 | A20 | A22 |
| R1 | −3.71196E−01 | 1.66571E−03 | −3.95209E−04 | 5.45051E−05 | −3.30953E−06 | 0.00000E+00 |
| R2 | −5.22015E+01 | −1.87689E−04 | 2.49121E−04 | −5.34654E−05 | 3.85606E−06 | 0.00000E+00 |
| R3 | −5.09060E+02 | 1.26010E−01 | −4.28250E−02 | 8.20437E−03 | −6.76897E−04 | 0.00000E+00 |
| R4 | 1.27404E+01 | 5.93439E−01 | −1.07684E−01 | −5.92693E−02 | 3.61788E−02 | −5.84195E−03 |
| R5 | −5.50135E+00 | 5.00658E+02 | −8.69187E+02 | 1.08346E+03 | −9.73205E+02 | 6.24435E+02 |
| R6 | −3.01722E−02 | 1.04565E+03 | −2.21134E+03 | 3.31893E+03 | −3.55381E+03 | 2.69451E+03 |
| R7 | 9.99000E+02 | −9.45094E+02 | 1.33871E+03 | −1.23192E+03 | 6.21933E+02 | −6.21163E−01 |
| R8 | 9.95509E+02 | −3.78890E+02 | 5.40565E+02 | −5.64703E+02 | 4.31755E+02 | −2.38686E+02 |
| R9 | −3.00354E+01 | −4.64733E−01 | 3.00612E−01 | −1.38071E−01 | 4.52344E−02 | −1.04942E−02 |
| R10 | −1.73376E+02 | −2.40704E−01 | 1.20841E−01 | −4.31388E−02 | 1.08964E−02 | −1.91135E−03 |
| R11 | −3.21295E−03 | −1.36114E−01 | 5.09628E−02 | −1.36940E−02 | 2.71219E−03 | −4.00847E−04 |
| R12 | 1.81538E+00 | −2.46167E−02 | 1.01311E−02 | −3.27758E−03 | 8.24127E−04 | −1.54625E−04 |

| | Conic Coefficient | Aspheric Coefficient | | | |
|---|---|---|---|---|---|
| | k | A24 | A26 | A28 | A30 |
| R1 | −3.71196E−01 | 0.00000E+00 | 0.00000E+00 | 0.00000E+00 | 0.00000E+00 |
| R2 | −5.22015E+01 | 0.00000E+00 | 0.00000E+00 | 0.00000E+00 | 0.00000E+00 |
| R3 | −5.09060E+02 | 0.00000E+00 | 0.00000E+00 | 0.00000E+00 | 0.00000E+00 |
| R4 | 1.27404E+01 | 0.00000E+00 | 0.00000E+00 | 0.00000E+00 | 0.00000E+00 |
| R5 | −5.50135E+00 | −2.79132E+02 | 8.25703E+01 | −1.45257E+01 | 1.15036E+00 |
| R6 | −3.01722E−02 | −1.41199E+03 | 4.85886E+02 | −9.86603E+01 | 8.94326E+00 |
| R7 | 9.99000E+02 | −2.32004E+02 | 1.58802E+02 | −4.87564E+01 | 6.01948E+00 |
| R8 | 9.95509E+02 | 9.28028E+01 | −2.40553E+01 | 3.73039E+00 | −2.61746E−01 |
| R9 | −3.00354E+01 | 1.68483E−03 | −1.78220E−04 | 1.11893E−05 | −3.16360E−07 |
| R10 | −1.73376E+02 | 2.24425E−04 | −1.64744E−05 | 6.59052E−07 | −1.01200E−08 |
| R11 | −3.21295E−03 | 4.38067E−05 | −3.38195E−06 | 1.64801E−07 | −3.78612E−09 |
| R12 | 1.81538E+00 | 2.05433E−05 | −1.80538E−06 | 9.35356E−08 | −2.15542E−09 |

For convenience, the aspheric surface of each lens surface uses the aspheric surface shown in following formula (1). However, the present disclosure is not limited to the aspheric polynomial form shown in formula (1).

$$z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} ++ A 18 {r}^{18} + A 20 {r}^{20} + A 22 {r}^{22} + A 24 {r}^{24} + A 26 {r}^{26} + A 28 {r}^{28} + A 30 {r}^{30} \qquad ( 1 )$$

Where k denotes a conic coefficient, A4, A6, A8, A10, A12, A14, A16, A18, A20, A22, A24, A26, A28 and A30 denote aspheric coefficients, c denotes a curvature at a center of an optical surface, r denotes a vertical distance between a point on an aspheric curve and an optical axis, and z denotes an aspheric depth (a vertical distance between a point on the aspheric surface, with a distance r from the optical axis, and a tangent plane tangent to a vertex on the aspheric optical axis).

Table 3 and Table 4 show design data of inflection points and arrest points of each lens in the camera optical lens 10 according to Embodiment 1 of the present disclosure. P1R1 and P1R2 respectively denote the object side surface and the image side surface of the first lens L1, P2R1 and P2R2 respectively denote the object side surface and the image side surface of the second lens L2, P3R1 and P3R2 respectively denote the object side surface and the image side surface of the third lens L3, P4R1 and P4R2 respectively denote the object side surface and the image side surface of the fourth lens L4, P5R1 and P5R2 respectively denote the object side surface and the image side surface of the fifth lens L5, P6R1 and P6R2 respectively denote the object side surface and the image side surface of the fifth lens L6. The corresponding data in the column “Inflection Point Position” is a vertical distance from the inflection points on the surface of each lens to the optical axis of the camera optical lens 10. The corresponding data in the column “Arrest Point Position” is a vertical distance from the arrest points on the surface of each lens to the optical axis of the camera optical lens 10.

TABLE 3

| | Number of | Inflection | Inflection | Inflection |
|---|---|---|---|---|
| | Inflection | Point | Point | Point |
| | Points | Position 1 | Position 2 | Position 3 |
| P1R1 | 1 | 1.805 | / | / |
| P1R2 | 2 | 0.745 | 1.365 | / |
| P2R1 | 2 | 0.315 | 1.555 | / |
| P2R2 | 2 | 1.325 | 1.375 | / |
| P3R1 | / | / | / | / |
| P3R2 | 1 | 1.165 | / | / |
| P4R1 | 1 | 1.185 | / | / |
| P4R2 | 2 | 1.275 | 1.325 | / |
| P5R1 | 3 | 0.325 | 1.735 | 2.135 |
| P5R2 | 2 | 1.875 | 2.245 | / |
| P6R1 | 2 | 1.395 | 2.405 | / |
| P6R2 | 2 | 2.235 | 2.575 | / |

TABLE 4

| | Number of Arrest Points | Arrest Point Position 1 |
|---|---|---|
| P1R1 | / | / |
| P1R2 | / | / |
| P2R1 | 1 | 0.455 |
| P2R2 | / | / |
| P3R1 | / | / |
| P3R2 | / | / |
| P4R1 | / | / |
| P4R2 | / | / |
| P5R1 | 1 | 0.565 |
| P5R2 | / | / |
| P6R1 | / | / |
| P6R2 | / | / |

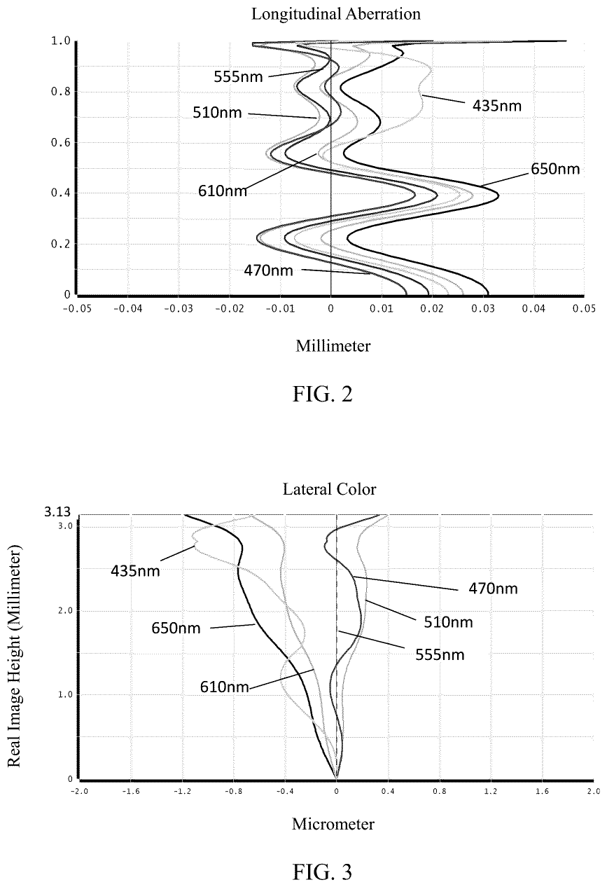

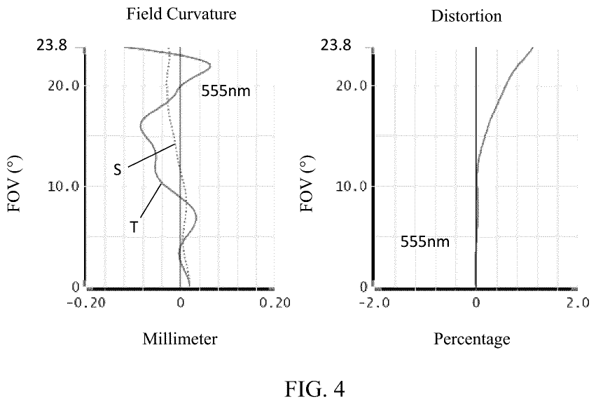

FIG. 2 and FIG. 3 respectively show longitudinal aberration and lateral color of light with wavelengths of 650 nm, 610 nm, 555 nm, 510 nm, 470 nm, and 435 nm after passing through the camera optical lens 10 according to Embodiment 1. FIG. 4 shows field curvature and distortion of light with a wavelength of 555 nm after passing through the camera optical lens 10 according to Embodiment 1, the field curvature S in FIG. 4 is a field curvature in a sagittal direction, and T is a field curvature in a meridian direction.

Table 25 below shows various values in each embodiment and values corresponding to the parameters specified in the relational expressions.

As shown in Table 25, Embodiment 1 satisfies relational expressions.

An entrance pupil diameter ENPD of the camera optical lens 10 is 3.724 mm, the full field of view image height IH is 3.133 mm, and the field of view FOV in a diagonal direction is 47.57°, the camera optical lens 10 meets the design requirements of large-aperture and ultra-thinness, the on-axis and off-axis chromatic aberration are fully corrected, and has excellent optical characteristics.

### Embodiment 2

Embodiment 2 is substantially the same as Embodiment 1, the reference signs have the same meaning as Embodiment 1, and only differences are listed below.

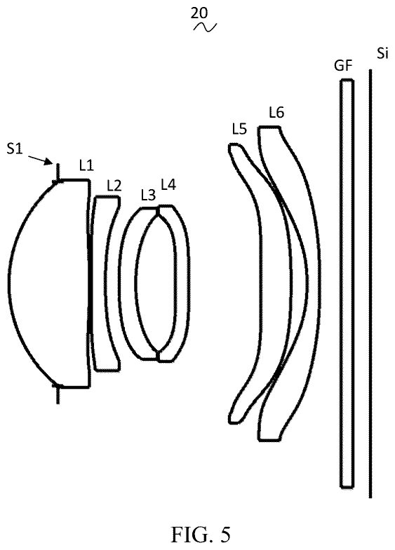

FIG. 5 shows a camera optical lens 20 according to Embodiment 2 of the present disclosure.

Table 5 and Table 6 show design data of the camera optical lens 20 according to Embodiment 2 of the present disclosure.

TABLE 5

| | R | d | | nd | | νd | |
|---|---|---|---|---|---|---|---|
| S1 | ∞ | d0= | −0.863 | | | | |
| R1 | 2.079 | d1= | 1.425 | nd1 | 1.5444 | ν1 | 55.82 |
| R2 | −8.148 | d2= | 0.034 | | | | |
| R3 | −65.515 | d3= | 0.244 | nd2 | 1.6700 | ν2 | 19.39 |
| R4 | 5.255 | d4= | 0.241 | | | | |
| R5 | 4.944 | d5= | 0.296 | nd3 | 1.5444 | ν3 | 55.82 |
| R6 | 2.571 | d6= | 0.703 | | | | |
| R7 | −2010.370 | d7= | 0.233 | nd4 | 1.6610 | ν4 | 20.53 |
| R8 | −79.368 | d8= | 1.276 | | | | |
| R9 | 56.322 | d9= | 0.531 | nd5 | 1.6610 | ν5 | 20.53 |
| R10 | −11.364 | d10= | 0.284 | | | | |
| R11 | −2.649 | d11= | 0.221 | nd6 | 1.5346 | ν6 | 55.69 |
| R12 | −16.515 | d12= | 0.378 | | | | |
| R13 | ∞ | d13= | 0.210 | ndg | 1.5168 | νg | 64.17 |
| R14 | ∞ | d14= | 0.312 | | | | |

Table 6 shows aspheric surface data of each lens in the camera optical lens 20 according to Embodiment 2 of the present disclosure.

TABLE 6

| | |
|---|---|
| Conic Coefficient | Aspheric Coefficient |

| | k | A4 | A6 | A8 | A10 | A12 |
|---|---|---|---|---|---|---|
| R1 | −3.56125E−01 | −6.10890E−04 | 8.55000E−03 | −1.03480E−02 | 8.45190E−03 | −4.56270E−03 |
| R2 | −1.14680E+02 | 1.15350E−02 | 1.56130E−02 | −1.92340E−02 | 1.07880E−02 | −2.46800E−03 |
| R3 | 1.74536E+03 | −1.12520E−02 | 1.16700E−01 | −2.19390E−01 | 2.75210E−01 | −2.30680E−01 |
| R4 | 1.26072E+01 | −5.51190E−02 | 2.72940E−01 | −6.73930E−01 | 1.09260E+00 | −1.08320E+00 |
| R5 | −1.81759E+00 | −4.97100E−02 | 1.29380E+00 | −1.06760E+01 | 5.72770E+01 | −2.04010E+02 |
| R6 | −4.38825E−02 | −6.61550E−02 | 1.17850E+00 | −1.15430E+01 | 7.74990E+01 | −3.45150E+02 |
| R7 | −7.49627E+04 | 1.62290E−01 | −3.98760E+00 | 3.08270E+01 | −1.45910E+02 | 4.51710E+02 |
| R8 | 2.74403E+03 | 1.30190E−01 | −2.59830E+00 | 1.68630E+01 | −6.91490E+01 | 1.92410E+02 |
| R9 | 3.94637E+02 | −2.83340E−02 | −3.40530E−02 | 1.61380E−01 | −3.64540E−01 | 5.01800E−01 |
| R10 | −5.47840E+01 | −5.29000E−02 | −2.83060E−02 | 1.75430E−01 | −3.17530E−01 | 3.37050E−01 |
| R11 | 9.22861E−03 | −8.25170E−02 | 1.67930E−02 | 1.73650E−01 | −2.91600E−01 | 2.49930E−01 |
| R12 | 1.90610E+01 | −6.48170E−02 | 2.93740E−02 | 2.66470E−02 | −5.40360E−02 | 4.49450E−02 |

| | Conic Coefficient | Aspheric Coefficient | | | | |
|---|---|---|---|---|---|---|
| | k | A14 | A16 | A18 | A20 | A22 |
| R1 | −3.56125E−01 | 1.66760E−03 | −3.94720E−04 | 5.47650E−05 | −3.17810E−06 | 0.00000E+00 |
| R2 | −1.14680E+02 | −1.77840E−04 | 2.49600E−04 | −5.45450E−05 | 2.21020E−06 | 0.00000E+00 |
| R3 | 1.74536E+03 | 1.25990E−01 | −4.28400E−02 | 8.19760E−03 | −6.77040E−04 | 0.00000E+00 |
| R4 | 1.26072E+01 | 5.93200E−01 | −1.07770E−01 | −5.92740E−02 | 3.61930E−02 | −5.82770E−03 |
| R5 | −1.81759E+00 | 5.00660E+02 | −8.69190E+02 | 1.08350E+03 | −9.73210E+02 | 6.24440E+02 |
| R6 | −4.38825E−02 | 1.04560E+03 | −2.21130E+03 | 3.31890E+03 | −3.55380E+03 | 2.69450E+03 |
| R7 | −7.49627E+04 | −9.45090E+02 | 1.33870E+03 | −1.23190E+03 | 6.21930E+02 | −6.21040E−01 |
| R8 | 2.74403E+03 | −3.78890E+02 | 5.40570E+02 | −5.64700E+02 | 4.31760E+02 | −2.38690E+02 |
| R9 | 3.94637E+02 | −4.64730E−01 | 3.00610E−01 | −1.38070E−01 | 4.52340E−02 | −1.04940E−02 |
| R10 | −5.47840E+01 | −2.40700E−01 | 1.20840E−01 | −4.31390E−02 | 1.08960E−02 | −1.91140E−03 |
| R11 | 9.22861E−03 | −1.36110E−01 | 5.09630E−02 | −1.36940E−02 | 2.71220E−03 | −4.00850E−04 |
| R12 | 1.90610E+01 | −2.46170E−02 | 1.01310E−02 | −3.27760E−03 | 8.24130E−04 | −1.54620E−04 |

| | Conic Coefficient | Aspheric Coefficient | | | |
|---|---|---|---|---|---|
| | k | A24 | A26 | A28 | A30 |
| R1 | −3.56125E−01 | 0.00000E+00 | 0.00000E+00 | 0.00000E+00 | 0.00000E+00 |
| R2 | −1.14680E+02 | 0.00000E+00 | 0.00000E+00 | 0.00000E+00 | 0.00000E+00 |
| R3 | 1.74536E+03 | 0.00000E+00 | 0.00000E+00 | 0.00000E+00 | 0.00000E+00 |
| R4 | 1.26072E+01 | 0.00000E+00 | 0.00000E+00 | 0.00000E+00 | 0.00000E+00 |
| R5 | −1.81759E+00 | −2.79130E+02 | 8.25700E+01 | −1.45260E+01 | 1.15040E+00 |
| R6 | −4.38825E−02 | −1.41200E+03 | 4.85890E+02 | −9.86600E+01 | 8.94320E+00 |
| R7 | −7.49627E+04 | −2.32000E+02 | 1.58800E+02 | −4.87560E+01 | 6.01950E+00 |
| R8 | 2.74403E+03 | 9.28030E+01 | −2.40550E+01 | 3.73040E+00 | −2.61750E−01 |
| R9 | 3.94637E+02 | 1.68480E−03 | −1.78220E−04 | 1.11890E−05 | −3.16370E−07 |
| R10 | −5.47840E+01 | 2.24420E−04 | −1.64740E−05 | 6.59050E−07 | −1.01180E−08 |
| R11 | 9.22861E−03 | 4.38070E−05 | −3.38190E−06 | 1.64800E−07 | −3.78610E−09 |
| R12 | 1.90610E+01 | 2.05430E−05 | −1.80540E−06 | 9.35360E−08 | −2.15540E−09 |

Table 7 and Table 8 show design data of inflection points and arrest points of each lens in the camera optical lens 20 according to Embodiment 2 of the present disclosure.

TABLE 7

| | Number of | Inflection | Inflection | Inflection |
|---|---|---|---|---|
| | Inflection | Point | Point | Point |
| | Points | Position 1 | Position 2 | Position 3 |
| P1R1 | / | / | / | / |
| P1R2 | 2 | 0.565 | 1.515 | / |
| P2R1 | 2 | 0.345 | 1.315 | / |
| P2R2 | 3 | 1.225 | 1.395 | 1.425 |
| P3R1 | / | / | / | / |
| P3R2 | 1 | 1.195 | / | / |
| P4R1 | 3 | 0.025 | 0.155 | 1.185 |
| P4R2 | / | / | / | / |
| P5R1 | 3 | 0.225 | 1.785 | 2.125 |
| P5R2 | 2 | 1.885 | 2.225 | / |
| P6R1 | 2 | 1.675 | 2.425 | / |
| P6R2 | 2 | 2.285 | 2.615 | / |

TABLE 8

| | Number of | Arrest Point | Arrest Point | Arrest Point |
|---|---|---|---|---|
| | Arrest Points | Position 1 | Position 2 | Position 3 |
| P1R1 | / | / | / | / |
| P1R2 | 1 | 1.055 | / | / |
| P2R1 | 2 | 0.525 | 1.485 | / |
| P2R2 | / | / | / | / |
| P3R1 | / | / | / | / |
| P3R2 | / | / | / | / |
| P4R1 | 3 | 0.025 | 0.195 | 1.225 |
| P4R2 | / | / | / | / |
| P5R1 | 1 | 0.375 | / | / |
| P5R2 | / | / | / | / |
| P6R1 | / | / | / | / |
| P6R2 | / | / | / | / |

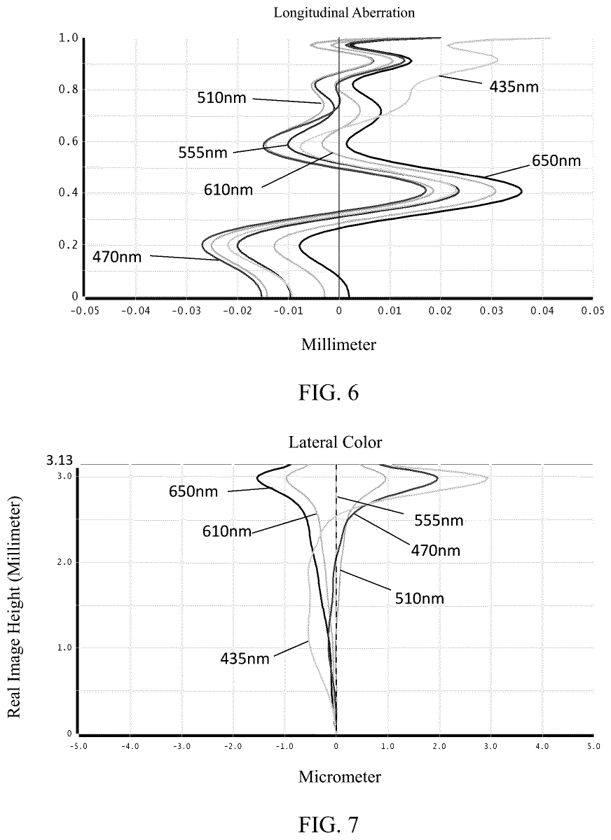

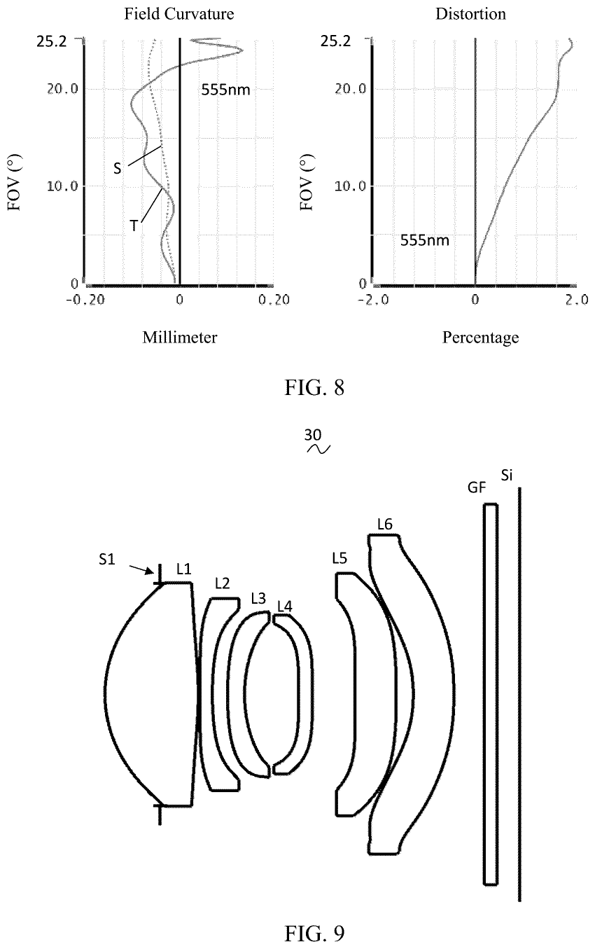

FIG. 6 and FIG. 7 respectively show longitudinal aberration and lateral color of light with wavelengths of 650 nm, 610 nm, 555 nm, 510 nm, 470 nm, and 435 nm after passing through the camera optical lens 20 according to Embodiment 2. FIG. 8 shows field curvature and distortion of light with a wavelength of 555 nm after passing through the camera optical lens 20 according to Embodiment 2. The field curvature S in FIG. 8 is the field curvature in a sagittal direction, and T is the field curvature in a meridian direction.

As shown in Table 25, Embodiment 2 satisfies relational expressions.

In the embodiment, the entrance pupil diameter ENPD of the camera optical lens 20 is 3.436 mm, the full field of view image height IH is 3.133 mm, and the field of view FOV in the diagonal direction is 50.37°, the camera optical lens 20 meets the design requirements of large-aperture and ultra-thinness, the on-axis and off-axis chromatic aberration are fully corrected, and has excellent optical characteristics.

### Embodiment 3

Embodiment 3 is substantially the same as Embodiment 1, the reference signs have the same meaning as Embodiment 1, and only differences are listed below.

FIG. 9 shows a camera optical lens 30 according to Embodiment 3 of the present disclosure.

Table 9 and Table 10 show design data of the camera optical lens 30 according to Embodiment 3 of the present disclosure.

TABLE 9

| | R | d | | nd | | νd | |
|---|---|---|---|---|---|---|---|
| S1 | ∞ | d0= | −0.906 | | | | |
| R1 | 2.083 | d1= | 1.532 | nd1 | 1.5444 | ν1 | 55.82 |
| R2 | −6.078 | d2= | 0.031 | | | | |
| R3 | −89.133 | d3= | 0.200 | nd2 | 1.6700 | ν2 | 19.39 |
| R4 | 5.304 | d4= | 0.250 | | | | |
| R5 | 5.934 | d5= | 0.279 | nd3 | 1.5444 | ν3 | 55.82 |
| R6 | 2.366 | d6= | 0.888 | | | | |
| R7 | −37.064 | d7= | 0.223 | nd4 | 1.6610 | ν4 | 20.53 |
| R8 | −2240.254 | d8= | 0.699 | | | | |
| R9 | 19.426 | d9= | 0.678 | nd5 | 1.6610 | ν5 | 20.53 |
| R10 | −24.244 | d10= | 0.281 | | | | |
| R11 | −2.625 | d11= | 0.667 | nd6 | 1.5346 | ν6 | 55.69 |
| R12 | −5.831 | d12= | 0.495 | | | | |
| R13 | ∞ | d13= | 0.210 | ndg | 1.5168 | νg | 64.17 |
| R14 | ∞ | d14= | 0.375 | | | | |

Table 10 shows aspheric surface data of each lens in the camera optical lens 30 according to Embodiment 3 of the present disclosure.

TABLE 10

| | |
|---|---|
| Conic Coefficient | Aspheric Coefficient |

| | k | A4 | A6 | A8 | A10 | A12 |
|---|---|---|---|---|---|---|
| R1 | −3.68985E−01 | −1.42200E−03 | 8.40330E−03 | −1.04540E−02 | 8.41500E−03 | −4.57340E−03 |
| R2 | −4.41152E+01 | 7.48160E−03 | 1.47540E−02 | −1.95620E−02 | 1.07170E−02 | −2.50990E−03 |
| R3 | −1.78841E+03 | −9.92240E−03 | 1.18000E−01 | −2.19130E−01 | 2.75190E−01 | −2.30680E−01 |
| R4 | 1.25366E+01 | −4.42470E−02 | 2.72100E−01 | −6.72470E−01 | 1.09340E+00 | −1.08260E+00 |
| R5 | 3.87495E+00 | −6.13490E−02 | 1.28670E+00 | −1.06790E+01 | 5.72770E+01 | −2.04010E+02 |
| R6 | 7.37301E−02 | −7.75730E−02 | 1.16390E+00 | −1.15350E+01 | 7.75010E+01 | −3.45170E+02 |
| R7 | 8.53561E+02 | 1.52810E−01 | −3.98440E+00 | 3.08310E+01 | −1.45910E+02 | 4.51700E+02 |
| R8 | 1.42267E+06 | 1.11070E−01 | −2.60110E+00 | 1.68680E+01 | −6.91520E+01 | 1.92410E+02 |
| R9 | 5.62573E+01 | −4.38540E−02 | −3.82010E−02 | 1.61960E−01 | −3.64510E−01 | 5.01820E−01 |
| R10 | −2.90834E+02 | −5.85870E−02 | −2.82800E−02 | 1.75940E−01 | −3.17540E−01 | 3.37040E−01 |
| R11 | 3.62248E−02 | −7.88650E−02 | 1.75170E−02 | 1.73630E−01 | −2.91610E−01 | 2.49930E−01 |
| R12 | 9.27639E−01 | −6.47200E−02 | 2.94180E−02 | 2.67420E−02 | −5.40280E−02 | 4.49450E−02 |

| | Conic Coefficient | Aspheric Coefficient | | | | |
|---|---|---|---|---|---|---|
| | k | A14 | A16 | A18 | A20 | A22 |
| R1 | −3.68985E−01 | 1.66510E−03 | −3.95290E−04 | 5.45240E−05 | −3.28310E−06 | 0.00000E+00 |
| R2 | −4.41152E+01 | −1.88100E−04 | 2.48930E−04 | −5.34540E−05 | 3.89090E−06 | 0.00000E+00 |
| R3 | −1.78841E+03 | 1.26030E−01 | −4.28330E−02 | 8.20210E−03 | −6.76190E−04 | 0.00000E+00 |
| R4 | 1.25366E+01 | 5.93510E−01 | −1.07640E−01 | −5.92490E−02 | 3.61820E−02 | −5.84500E−03 |
| R5 | 3.87495E+00 | 5.00660E+02 | −8.69190E+02 | 1.08350E+03 | −9.73210E+02 | 6.24440E+02 |
| R6 | 7.37301E−02 | 1.04570E+03 | −2.21130E+03 | 3.31890E+03 | −3.55380E+03 | 2.69450E+03 |
| R7 | 8.53561E+02 | −9.45090E+02 | 1.33870E+03 | −1.23190E+03 | 6.21930E+02 | −6.21350E−01 |
| R8 | 1.42267E+06 | −3.78890E+02 | 5.40570E+02 | −5.64700E+02 | 4.31750E+02 | −2.38690E+02 |
| R9 | 5.62573E+01 | −4.64730E−01 | 3.00610E−01 | −1.38070E−01 | 4.52340E−02 | −1.04940E−02 |
| R10 | −2.90834E+02 | −2.40710E−01 | 1.20840E−01 | −4.31390E−02 | 1.08960E−02 | −1.91140E−03 |
| R11 | 3.62248E−02 | −1.36110E−01 | 5.09630E−02 | −1.36940E−02 | 2.71220E−03 | −4.00850E−04 |
| R12 | 9.27639E−01 | −2.46170E−02 | 1.01310E−02 | −3.27760E−03 | 8.24130E−04 | −1.54620E−04 |

| | Conic Coefficient | Aspheric Coefficient | | | |
|---|---|---|---|---|---|
| | k | A24 | A26 | A28 | A30 |
| R1 | −3.68985E−01 | 0.00000E+00 | 0.00000E+00 | 0.00000E+00 | 0.00000E+00 |
| R2 | −4.41152E+01 | 0.00000E+00 | 0.00000E+00 | 0.00000E+00 | 0.00000E+00 |
| R3 | −1.78841E+03 | 0.00000E+00 | 0.00000E+00 | 0.00000E+00 | 0.00000E+00 |
| R4 | 1.25366E+01 | 0.00000E+00 | 0.00000E+00 | 0.00000E+00 | 0.00000E+00 |
| R5 | 3.87495E+00 | −2.79130E+02 | 8.25700E+01 | −1.45260E+01 | 1.15040E+00 |
| R6 | 7.37301E−02 | −1.41200E+03 | 4.85890E+02 | −9.86600E+01 | 8.94330E+00 |
| R7 | 8.53561E+02 | −2.32000E+02 | 1.58800E+02 | −4.87570E+01 | 6.02010E+00 |
| R8 | 1.42267E+06 | 9.28030E+01 | −2.40550E+01 | 3.73040E+00 | −2.61740E−01 |
| R9 | 5.62573E+01 | 1.68480E−03 | −1.78200E−04 | 1.11940E−05 | −3.17660E−07 |
| R10 | −2.90834E+02 | 2.24430E−04 | −1.64740E−05 | 6.59050E−07 | −1.01230E−08 |
| R11 | 3.62248E−02 | 4.38070E−05 | −3.38190E−06 | 1.64800E−07 | −3.78620E−09 |
| R12 | 9.27639E−01 | 2.05430E−05 | −1.80540E−06 | 9.35360E−08 | −2.15550E−09 |

Table 11 and Table 12 show design data of inflection points and arrest points of each lens in the camera optical lens 30 according to Embodiment 3 of the present disclosure.

TABLE 11

| | Number of | Inflection | Inflection | Inflection | Inflection |
|---|---|---|---|---|---|
| | Inflection | Point | Point | Point | Point |
| | Points | Position 1 | Position 2 | Position 3 | Position 4 |
| P1R1 | 1 | 1.875 | / | / | / |
| P1R2 | 2 | 0.775 | 1.495 | / | / |
| P2R1 | 2 | 0.305 | 1.545 | / | / |
| P2R2 | 3 | 1.345 | 1.425 | 1.445 | / |
| P3R1 | / | / | / | / | / |
| P3R2 | 1 | 1.185 | / | / | / |
| P4R1 | 1 | 1.195 | / | / | / |
| P4R2 | 4 | 0.025 | 0.155 | 1.305 | 1.365 |
| P5R1 | 2 | 0.305 | 1.745 | / | / |
| P5R2 | / | / | / | / | / |
| P6R1 | 2 | 1.365 | 2.385 | / | / |
| P6R2 | 2 | 2.205 | 2.605 | / | / |

TABLE 12

| | Number of Arrest | Arrest Point | Arrest Point |
|---|---|---|---|
| | Points | Position 1 | Position 2 |
| P1R1 | / | / | / |
| P1R2 | / | / | / |
| P2R1 | 1 | 0.455 | / |
| P2R2 | / | / | / |
| P3R1 | / | / | / |
| P3R2 | 1 | 1.215 | / |
| P4R1 | / | / | / |
| P4R2 | 2 | 0.035 | 0.195 |
| P5R1 | 1 | 0.525 | / |
| P5R2 | / | / | / |
| P6R1 | 2 | 2.245 | 2.435 |
| P6R2 | / | / | / |

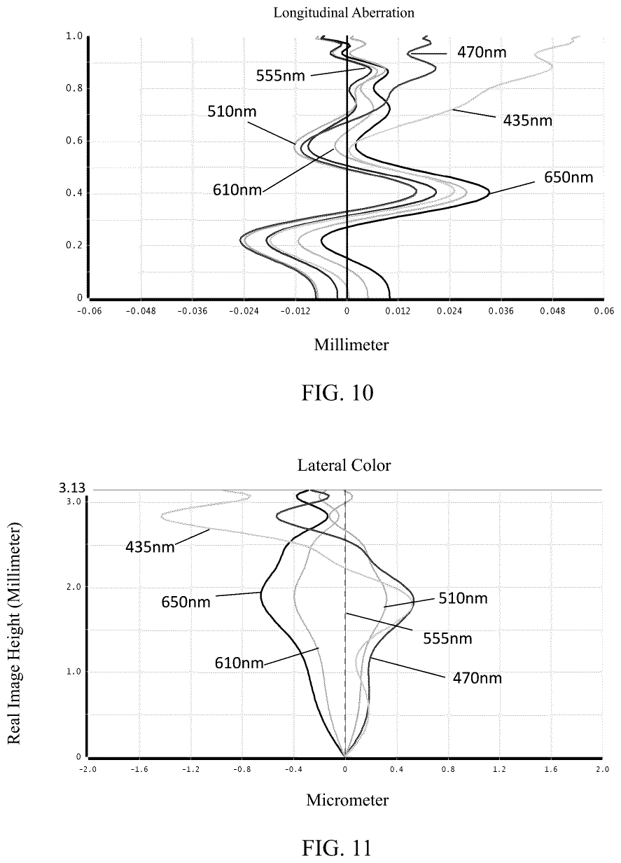

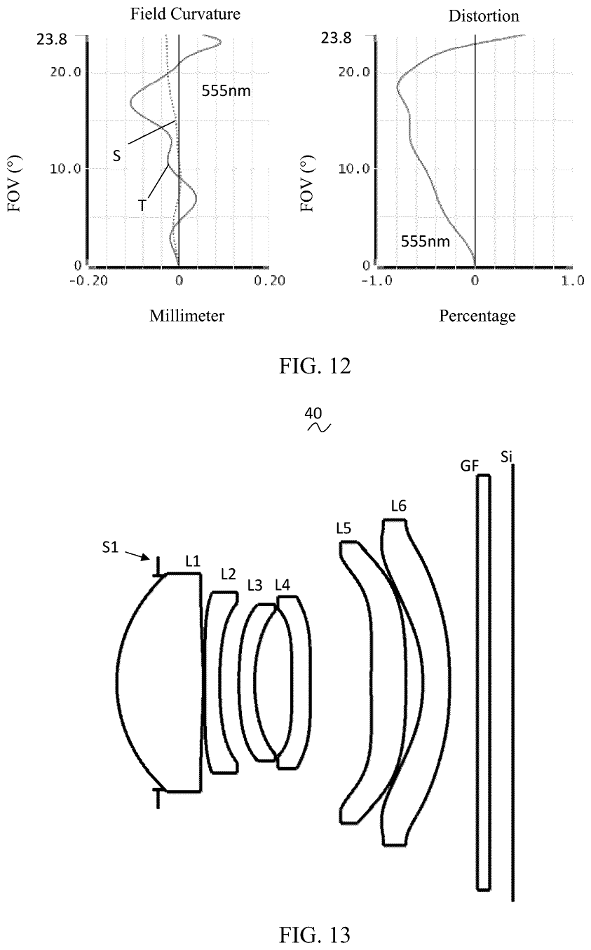

FIG. 10 and FIG. 11 show longitudinal aberration and lateral color of light with wavelengths of 650 nm, 610 nm, 555 nm, 510 nm, 470 nm, and 435 nm after passing through the camera optical lens 30 according to Embodiment 3. FIG. 12 shows field curvature and distortion of light with a wavelength of 555 nm after passing through the camera optical lens 20 according to Embodiment 2. The field curvature S in FIG. 12 is the field curvature in a sagittal direction, and T is the field curvature in a meridian direction.

As shown in Table 25, Embodiment 3 satisfies relational expressions.

In the embodiment, the entrance pupil diameter ENPD of the camera optical lens 30 is 3.715 mm, the full field of view image height IH is 3.133 mm, and the field of view FOV in the diagonal direction is 47.65°, the camera optical lens 30 meets the design requirements of large-aperture and ultra-thinness, the on-axis and off-axis chromatic aberration are fully corrected, and has excellent optical characteristics.

### Embodiment 4

Embodiment 4 is substantially the same as Embodiment 1, the reference signs have the same meaning as Embodiment 1, and only differences are listed below.

FIG. 13 shows a camera optical lens 40 according to Embodiment 4 of the present disclosure.

Table 13 and Table 14 show design data of the camera optical lens 40 according to Embodiment 4 of the present disclosure.

TABLE 13

| | R | d | | nd | | νd | |
|---|---|---|---|---|---|---|---|
| S1 | ∞ | d0= | −0.707 | | | | |
| R1 | 2.065 | d1= | 1.472 | nd1 | 1.5444 | ν1 | 55.82 |
| R2 | −8.924 | d2= | 0.030 | | | | |
| R3 | −113.033 | d3= | 0.249 | nd2 | 1.6700 | ν2 | 19.39 |
| R4 | 5.142 | d4= | 0.327 | | | | |
| R5 | 5.169 | d5= | 0.269 | nd3 | 1.5444 | ν3 | 55.82 |
| R6 | 2.507 | d6= | 0.632 | | | | |
| R7 | 29.693 | d7= | 0.314 | nd4 | 1.6610 | ν4 | 20.53 |
| R8 | 70.879 | d8= | 1.036 | | | | |
| R9 | 18.248 | d9= | 0.591 | nd5 | 1.6610 | ν5 | 20.53 |
| R10 | −22.590 | d10= | 0.290 | | | | |
| R11 | −2.688 | d11= | 0.455 | nd6 | 1.5346 | ν6 | 55.69 |
| R12 | −6.854 | d12= | 0.469 | | | | |
| R13 | ∞ | d13= | 0.210 | ndg | 1.5168 | νg | 64.17 |
| R14 | ∞ | d14= | 0.399 | | | | |

Table 14 shows aspheric surface data of each lens in the camera optical lens 40 according to Embodiment 4 of the present disclosure.

TABLE 14

| | Conic Coefficient | Aspheric Coefficient | | | | |
|---|---|---|---|---|---|---|
| | k | A4 | A6 | A8 | A10 | A12 |
| R1 | −3.31932E−01 | −4.56000E−04 | 8.11610E−03 | −1.03750E−02 | 8.44140E−03 | −4.56860E−03 |
| R2 | −1.01816E+02 | 8.29420E−03 | 1.38790E−02 | −1.91020E−02 | 1.08040E−02 | −2.52240E−03 |
| R3 | 2.30814E+03 | −9.83980E−03 | 1.17170E−01 | −2.18980E−01 | 2.75630E−01 | −2.30640E−01 |
| R4 | 1.24831E+01 | −4.92980E−02 | 2.74360E−01 | −6.73360E−01 | 1.09560E+00 | −1.08350E+00 |
| R5 | −4.91484E+00 | −5.71750E−02 | 1.29610E+00 | −1.06760E+01 | 5.72770E+01 | −2.04010E+02 |
| R6 | 6.37673E−02 | −7.18600E−02 | 1.17560E+00 | −1.15400E+01 | 7.75090E+01 | −3.45160E+02 |
| R7 | 1.63420E−01 | −3.97500E+00 | 3.08360E+01 | −1.45910E+02 | 4.51700E+02 | −9.45090E+02 |
| R8 | 2.45378E+03 | 1.29740E−01 | −2.59170E+00 | 1.68700E+01 | −6.91500E+01 | 1.92410E+02 |
| R9 | −5.18632E+01 | −3.45450E−02 | −3.56870E−02 | 1.61530E−01 | −3.64520E−01 | 5.01800E−01 |
| R10 | −7.36908E+02 | −5.63480E−02 | −2.75260E−02 | 1.75470E−01 | −3.17530E−01 | 3.37040E−01 |
| R11 | 2.36314E−03 | −8.02950E−02 | 1.72420E−02 | 1.73630E−01 | −2.91600E−01 | 2.49930E−01 |
| R12 | −1.70445E+00 | −6.46290E−02 | 2.93110E−02 | 2.67270E−02 | −5.40340E−02 | 4.49450E−02 |

| | |
|---|---|
| Conic Coefficient | Aspheric Coefficient |

| | k | A14 | A16 | A18 | A20 | A22 |
|---|---|---|---|---|---|---|
| R1 | −3.31932E−01 | 1.66600E−03 | −3.97460E−04 | 5.42610E−05 | −3.12600E−06 | 0.00000E+00 |
| R2 | −1.01816E+02 | −2.09670E−04 | 2.43610E−04 | −5.13610E−05 | 4.72190E−06 | 0.00000E+00 |
| R3 | 2.30814E+03 | 1.25980E−01 | −4.28410E−02 | 8.17810E−03 | −6.61590E−04 | 0.00000E+00 |
| R4 | 1.24831E+01 | 5.93090E−01 | −1.07680E−01 | −5.92180E−02 | 3.62190E−02 | −5.83280E−03 |
| R5 | −4.91484E+00 | 5.00660E+02 | −8.69190E+02 | 1.08350E+03 | −9.73200E+02 | 6.24440E+02 |
| R6 | 6.37673E−02 | 1.04560E+03 | −2.21130E+03 | 3.31890E+03 | −3.55380E+03 | 2.69450E+03 |
| R7 | 1.63420E−01 | 1.33870E+03 | −1.23190E+03 | 6.21930E+02 | −6.21440E−01 | −2.32010E+02 |
| R8 | 2.45378E+03 | −3.78890E+02 | 5.40570E+02 | −5.64700E+02 | 4.31760E+02 | −2.38690E+02 |
| R9 | −5.18632E+01 | −4.64730E−01 | 3.00610E−01 | −1.38070E−01 | 4.52340E−02 | −1.04940E−02 |
| R10 | −7.36908E+02 | −2.40700E−01 | 1.20840E−01 | −4.31390E−02 | 1.08960E−02 | −1.91140E−03 |
| R11 | 2.36314E−03 | −1.36110E−01 | 5.09630E−02 | −1.36940E−02 | 2.71220E−03 | −4.00850E−04 |
| R12 | −1.70445E+00 | −2.46170E−02 | 1.01310E−02 | −3.27760E−03 | 8.24130E−04 | −1.54620E−04 |

| | Conic Coefficient | Aspheric Coefficient | | | |
|---|---|---|---|---|---|
| | k | A24 | A26 | A28 | A30 |
| R1 | −3.31932E−01 | 0.00000E+00 | 0.00000E+00 | 0.00000E+00 | 0.00000E+00 |
| R2 | −1.01816E+02 | 0.00000E+00 | 0.00000E+00 | 0.00000E+00 | 0.00000E+00 |
| R3 | 2.30814E+03 | 0.00000E+00 | 0.00000E+00 | 0.00000E+00 | 0.00000E+00 |
| R4 | 1.24831E+01 | 0.00000E+00 | 0.00000E+00 | 0.00000E+00 | 0.00000E+00 |
| R5 | −4.91484E+00 | −2.79130E+02 | 8.25700E+01 | −1.45260E+01 | 1.15040E+00 |
| R6 | 6.37673E−02 | −1.41200E+03 | 4.85890E+02 | −9.86610E+01 | 8.94290E+00 |
| R7 | 1.63420E−01 | 1.58800E+02 | −4.87570E+01 | 6.01980E+00 | 0.00000E+00 |
| R8 | 2.45378E+03 | 9.28030E+01 | −2.40550E+01 | 3.73040E+00 | −2.61740E−01 |
| R9 | −5.18632E+01 | 1.68480E−03 | −1.78220E−04 | 1.11890E−05 | −3.16390E−07 |
| R10 | −7.36908E+02 | 2.24420E−04 | −1.64740E−05 | 6.59050E−07 | −1.01180E−08 |
| R11 | 2.36314E−03 | 4.38070E−05 | −3.38190E−06 | 1.64800E−07 | −3.78620E−09 |
| R12 | −1.70445E+00 | 2.05430E−05 | −1.80540E−06 | 9.35360E−08 | −2.15550E−09 |

Table 15 and Table 16 show design data of inflection points and arrest points of each lens in the camera optical lens 40 according to Embodiment 4 of the present disclosure.

TABLE 15

| | Number of | Inflection | Inflection | Inflection |
|---|---|---|---|---|
| | Inflection | Point | Point | Point |
| | Points | Position 1 | Position 2 | Position 3 |
| P1R1 | / | / | / | / |
| P1R2 | 1 | 0.645 | / | / |
| P2R1 | 1 | 0.295 | / | / |
| P2R2 | / | / | / | / |
| P3R1 | / | / | / | / |
| P3R2 | 1 | 1.165 | / | / |
| P4R1 | 2 | 0.155 | 1.175 | / |
| P4R2 | 1 | 0.205 | / | / |
| P5R1 | 3 | 0.345 | 1.765 | 2.025 |
| P5R2 | / | / | / | / |
| P6R1 | 2 | 1.375 | 2.415 | / |
| P6R2 | 2 | 2.155 | 2.575 | / |

TABLE 16

| | Number of Arrest | Arrest Point | Arrest Point |
|---|---|---|---|
| | Points | Position 1 | Position 2 |
| P1R1 | / | / | / |
| P1R2 | 1 | 1.415 | / |
| P2R1 | 1 | 0.435 | / |
| P2R2 | / | / | / |
| P3R1 | / | / | / |
| P3R2 | 1 | 1.215 | / |
| P4R1 | 2 | 0.205 | 1.215 |
| P4R2 | 1 | 0.295 | / |
| P5R1 | 1 | 0.605 | / |
| P5R2 | / | / | / |
| P6R1 | 2 | 2.205 | 2.475 |
| P6R2 | / | / | / |

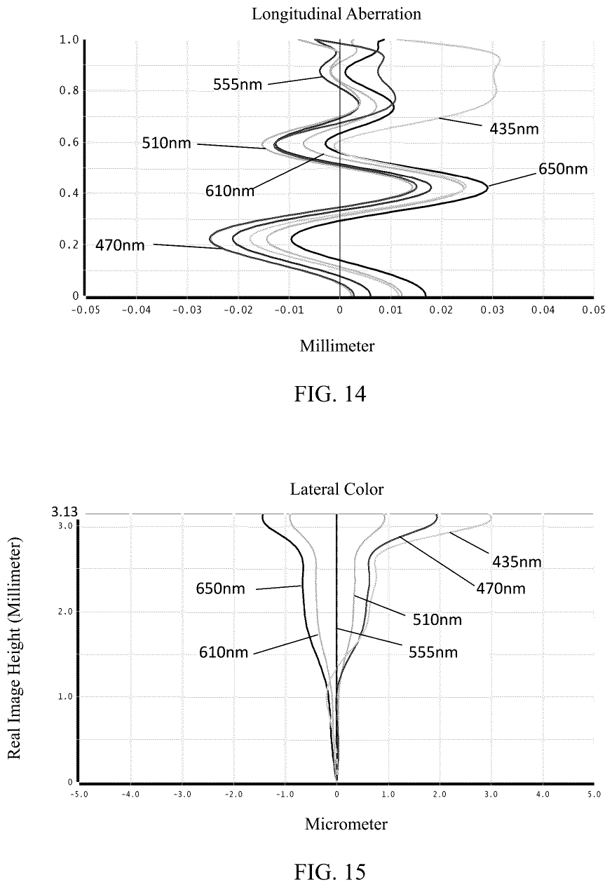

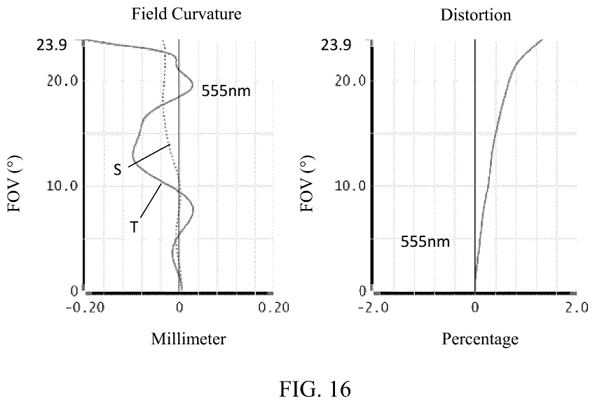

FIG. 14 and FIG. 15 respectively show longitudinal aberration and lateral color of light with wavelengths of 650 nm, 610 nm, 555 nm, 510 nm, 470 nm, and 435 nm after passing through the camera optical lens 40 according to Embodiment 4. FIG. 16 shows field curvature and distortion of light with a wavelength of 555 nm after passing through the camera optical lens 40 according to Embodiment 4. The field curvature S in FIG. 16 is the field curvature in a sagittal direction, and T is the field curvature in a meridian direction.

As shown in Table 25, Embodiment 4 satisfies relational expressions.

In the embodiment, the entrance pupil diameter ENPD of the camera optical lens 40 is 3.397 mm, the full field of view image height IH is 3.133 mm, and the field of view FOV in the diagonal direction is 47.82°, the camera optical lens 40 meets the design requirements of large-aperture and ultra-thinness, the on-axis and off-axis chromatic aberration are fully corrected, and has excellent optical characteristics.

### Embodiment 5

Embodiment 5 is substantially the same as Embodiment 1, the reference signs have the same meaning as Embodiment 1, and only differences are listed below.

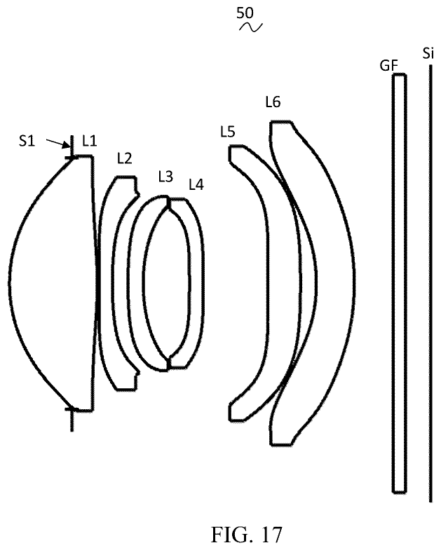

FIG. 17 shows a camera optical lens 50 according to Embodiment 5 of the present disclosure.

Table 17 and Table 18 show design data of the camera optical lens 50 according to Embodiment 5 of the present disclosure.

TABLE 17

| | R | d | | nd | | νd | |
|---|---|---|---|---|---|---|---|
| S1 | ∞ | d0= | −1.044 | | | | |
| R1 | 2.056 | d1= | 1.471 | nd1 | 1.5444 | ν1 | 55.82 |
| R2 | −5.871 | d2= | 0.032 | | | | |
| R3 | −37.644 | d3= | 0.220 | nd2 | 1.6700 | ν2 | 19.39 |
| R4 | 5.215 | d4= | 0.262 | | | | |
| R5 | 6.840 | d5= | 0.255 | nd3 | 1.5444 | ν3 | 55.82 |
| R6 | 2.409 | d6= | 0.775 | | | | |
| R7 | −39.081 | d7= | 0.229 | nd4 | 1.6610 | ν4 | 20.53 |
| R8 | −1473.789 | d8= | 1.087 | | | | |
| R9 | 35.502 | d9= | 0.545 | nd5 | 1.6610 | ν5 | 20.53 |
| R10 | −17.694 | d10= | 0.266 | | | | |
| R11 | −2.540 | d11= | 0.635 | nd6 | 1.5346 | ν6 | 55.69 |
| R12 | −3.974 | d12= | 0.650 | | | | |
| R13 | ∞ | d13= | 0.210 | ndg | 1.5168 | νg | 64.17 |
| R14 | ∞ | d14= | 0.417 | | | | |

Table 18 shows aspheric surface data of each lens in the camera optical lens 50 according to Embodiment 5 of the present disclosure.

TABLE 18

| | Conic Coefficient | Aspheric Coefficient | | | | |
|---|---|---|---|---|---|---|
| | k | A4 | A6 | A8 | A10 | A12 |
| R1 | −3.63715E−01 | −1.48750E−03 | 8.23990E−03 | −1.04260E−02 | 8.39380E−03 | −4.58310E−03 |
| R2 | −6.51934E+01 | 7.62650E−03 | 1.44480E−02 | −1.93710E−02 | 1.06620E−02 | −2.49560E−03 |
| R3 | −6.98890E+03 | −4.93160E−03 | 1.19110E−01 | −2.18870E−01 | 2.75090E−01 | −2.30580E−01 |
| R4 | 1.22904E+01 | −4.33450E−02 | 2.77350E−01 | −6.69870E−01 | 1.09250E+00 | −1.08180E+00 |
| R5 | −3.50891E+00 | −5.12050E−02 | 1.29010E+00 | −1.06770E+01 | 5.72780E+01 | −2.04010E+02 |
| R6 | 4.63112E−02 | −7.05270E−02 | 1.16740E+00 | −1.15370E+01 | 7.74970E+01 | −3.45160E+02 |
| R7 | 1.00939E+03 | 1.46210E−01 | −3.98350E+00 | 3.08360E+01 | −1.45910E+02 | 4.51700E+02 |
| R8 | 1.16450E−01 | −2.59960E+00 | 1.68690E+01 | −6.91460E+01 | 1.92410E+02 | −3.78890E+02 |
| R9 | −2.97050E+02 | −3.64710E−02 | −3.62940E−02 | 1.61530E−01 | −3.64470E−01 | 5.01790E−01 |
| R10 | 2.44229E+01 | −5.86380E−02 | −2.90640E−02 | 1.75930E−01 | −3.17460E−01 | 3.37030E−01 |
| R11 | 4.14616E−02 | −7.80850E−02 | 1.73140E−02 | 1.73630E−01 | −2.91600E−01 | 2.49930E−01 |
| R12 | 1.37552E+00 | −4.90330E−02 | 2.85350E−02 | 2.66560E−02 | −5.40340E−02 | 4.49450E−02 |
| | Conic Coefficient | Aspheric Coefficient | | | | |
| | k | A14 | A16 | A18 | A20 | A22 |
| R1 | −3.63715E−01 | 1.66340E−03 | −3.95080E−04 | 5.45880E−05 | −3.24680E−06 | 0.00000E+00 |
| R2 | −6.51934E+01 | −1.87310E−04 | 2.49370E−04 | −5.34290E−05 | 3.85860E−06 | 0.00000E+00 |
| R3 | −6.98890E+03 | 1.26060E−01 | 4.28370E−02 | 8.19480E−03 | −6.74730E−04 | 0.00000E+00 |
| R4 | 1.22904E+01 | 5.93550E−01 | −1.07800E−01 | −5.92490E−02 | 3.61810E−02 | −5.85550E−03 |
| R5 | −3.50891E+00 | 5.00660E+02 | −8.69190E+02 | 1.08350E+03 | −9.73200E+02 | 6.24440E+02 |
| R6 | 4.63112E−02 | 1.04560E+03 | −2.21130E+03 | 3.31890E+03 | −3.55380E+03 | 2.69450E+03 |
| R7 | 1.00939E+03 | −9.45090E+02 | 1.33870E+03 | −1.23190E+03 | 6.21930E+02 | −6.20700E−01 |
| R8 | 1.16450E−01 | 5.40560E+02 | −5.64700E+02 | 4.31760E+02 | −2.38690E+02 | 9.28030E+01 |
| R9 | −2.97050E+02 | −4.64740E−01 | 3.00610E−01 | −1.38070E−01 | 4.52340E−02 | −1.04940E−02 |
| R10 | 2.44229E+01 | −2.40700E−01 | 1.20840E−01 | −4.31390E−02 | 1.08960E−02 | −1.91130E−03 |
| R11 | 4.14616E−02 | −1.36110E−01 | 5.09630E−02 | −1.36940E−02 | 2.71220E−03 | −4.00850E−04 |
| R12 | 1.37552E+00 | −2.46170E−02 | 1.01310E−02 | −3.27760E−03 | 18.24130E−04 | −1.54620E−04 |

| | Conic Coefficient | Aspheric Coefficient | | | |
|---|---|---|---|---|---|
| | k | A24 | A26 | A28 | A30 |
| R1 | −3.63715E−01 | 0.00000E+00 | 0.00000E+00 | 0.00000E+00 | 0.00000E+00 |
| R2 | −6.51934E+01 | 0.00000E+00 | 0.00000E+00 | 0.00000E+00 | 0.00000E+00 |
| R3 | −6.98890E+03 | 0.00000E+00 | 0.00000E+00 | 0.00000E+00 | 0.00000E+00 |
| R4 | 1.22904E+01 | 0.00000E+00 | 0.00000E+00 | 0.00000E+00 | 0.00000E+00 |
| R5 | −3.50891E+00 | −2.79130E+02 | 8.25700E+01 | −1.45260E+01 | 1.15040E+00 |
| R6 | 4.63112E−02 | −1.41200E+03 | 4.85880E+02 | −9.86600E+01 | 8.94340E+00 |
| R7 | 1.00939E+03 | −2.32010E+02 | 1.58800E+02 | −4.87560E+01 | 6.01980E+00 |
| R8 | 1.16450E−01 | −2.40550E+01 | 3.73040E+00 | −2.61740E−01 | 0.00000E+00 |
| R9 | −2.97050E+02 | 1.68480E−03 | −1.78220E−04 | 1.11900E−05 | −3.15720E−07 |
| R10 | 2.44229E+01 | 2.24430E−04 | −1.64750E−05 | 6.59040E−07 | −1.01210E−08 |
| R11 | 4.14616E−02 | 4.38070E−05 | −3.38190E−06 | 1.64800E−07 | −3.78610E−09 |
| R12 | 1.37552E+00 | 2.05430E−05 | −1.80540E−06 | 9.35360E−08 | −2.15540E−09 |

Table 19 and Table 20 show design data of inflection points and arrest points of each lens in the camera optical lens 50 according to Embodiment 5 of the present disclosure.

TABLE 19

| | Number of | Inflection | Inflection | Inflection |
|---|---|---|---|---|
| | Inflection | Point | Point | Point |
| | Points | Position 1 | Position 2 | Position 3 |
| P1R1 | / | / | / | / |
| P1R2 | 2 | 0.695 | 1.845 | / |
| P2R1 | 2 | 0.305 | 1.585 | / |
| P2R2 | 3 | 1.335 | 1.405 | 1.435 |
| P3R1 | / | / | / | / |
| P3R2 | 1 | 1.185 | / | / |
| P4R1 | 1 | 1.185 | / | / |
| P4R2 | 2 | 0.155 | 1.255 | / |
| P5R1 | 2 | 0.245 | 1.805 | / |
| P5R2 | / | / | / | / |
| P6R1 | 1 | 1.415 | / | / |
| P6R2 | 1 | 2.235 | / | / |

TABLE 20

| | Number of Arrest | Arrest Point | Arrest Point |
|---|---|---|---|
| | Points | Position 1 | Position 2 |
| P1R1 | / | / | / |
| P1R2 | 1 | 1.695 | / |
| P2R1 | 1 | 0.485 | / |
| P2R2 | / | / | / |
| P3R1 | / | / | / |
| P3R2 | 1 | 1.225 | / |
| P4R1 | / | / | / |
| P4R2 | 1 | 0.205 | / |
| P5R1 | 2 | 0.415 | 1.925 |
| P5R2 | / | / | / |
| P6R1 | 1 | 2.255 | / |
| P6R2 | / | / | / |

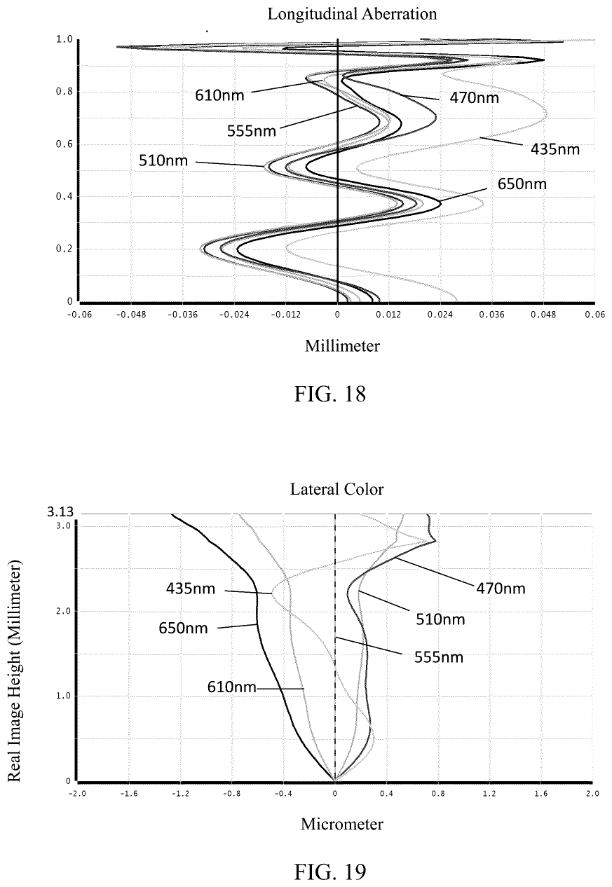

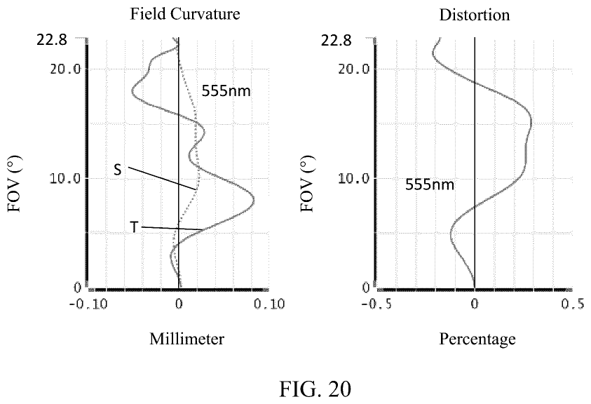

FIG. 18 and FIG. 19 respectively show longitudinal aberration and lateral color of light with wavelengths of 650 nm, 610 nm, 555 nm, 510 nm, 470 nm, and 435 nm after passing through the camera optical lens 50 according to Embodiment 5. FIG. 20 shows field curvature and distortion of light with a wavelength of 555 nm after passing through the camera optical lens 50 according to Embodiment 5. The field curvature S in FIG. 20 is the field curvature in a sagittal direction, and T is the field curvature in a meridian direction.

As shown in Table 25, Embodiment 5 satisfies relational expressions.

In the embodiment, the entrance pupil diameter ENPD of the camera optical lens 50 is 3.919 mm, the full field of view image height IH is 3.133 mm, and the field of view FOV in a diagonal direction is 45.72°, the camera optical lens 50 meets the design requirements of large-aperture and ultra-thinness, the on-axis and off-axis chromatic aberration are fully corrected, and has excellent optical characteristics.

### Comparative Embodiment

The meaning of the reference signs of Comparative Embodiment is the same as that of Embodiment 1, and only differences are listed below.

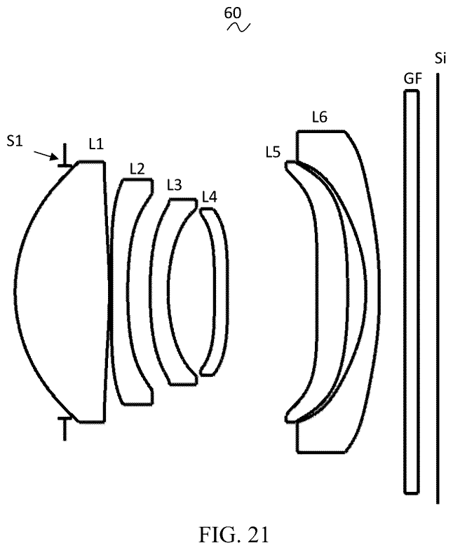

FIG. 21 shows a camera optical lens 60 according to Comparative Embodiment.

Table 21 and Table 22 show design data of the camera optical lens 60 according to Comparative Embodiment.

TABLE 21

| | R | d | | nd | | νd | |
|---|---|---|---|---|---|---|---|
| S1 | ∞ | d0= | −0.765 | | | | |
| R1 | 2.110 | d1= | 1.454 | nd1 | 1.5444 | ν1 | 55.82 |
| R2 | −7.639 | d2= | 0.034 | | | | |
| R3 | −101.307 | d3= | 0.247 | nd2 | 1.6700 | ν2 | 19.39 |
| R4 | 5.252 | d4= | 0.345 | | | | |
| R5 | 4.775 | d5= | 0.277 | nd3 | 1.5444 | ν3 | 55.82 |
| R6 | 2.333 | d6= | 0.714 | | | | |
| R7 | −43.746 | d7= | 0.201 | nd4 | 1.6610 | ν4 | 20.53 |
| R8 | −86.667 | d8= | 1.378 | | | | |
| R9 | 45.522 | d9= | 0.474 | nd5 | 1.6610 | ν5 | 20.53 |
| R10 | −11.667 | d10= | 0.281 | | | | |
| R11 | −2.669 | d11= | 0.209 | nd6 | 1.5346 | ν6 | 55.69 |
| R12 | −7.742 | d12= | 0.390 | | | | |
| R13 | ∞ | d13= | 0.210 | ndg | 1.5168 | νg | 64.17 |
| R14 | ∞ | d14= | 0.297 | | | | |

Table 22 shows aspheric surface data of each lens in the camera optical lens 60 according to Comparative Embodiment.

TABLE 22

| | |
|---|---|
| Conic Coefficient | Aspheric Coefficient |

| | k | A4 | A6 | A8 | A10 | A12 |
|---|---|---|---|---|---|---|
| R1 | −3.49825E−01 | −9.76940E−04 | 8.67810E−03 | −1.04280E−02 | 8.41300E−03 | −4.57300E−03 |
| R2 | −4.97991E+01 | 7.85690E−03 | 1.46600E−02 | −1.95820E−02 | 1.07100E−02 | −2.51100E−03 |
| R3 | 2.18816E+03 | −1.13550E−02 | 1.17160E−01 | −2.19260E−01 | 2.75210E−01 | −2.30660E−01 |
| R4 | 1.27536E+01 | −4.52130E−02 | 2.71760E−01 | −6.73580E−01 | 1.09320E+00 | −1.08270E+00 |
| R5 | −4.00011E+00 | −5.91790E−02 | 1.28860E+00 | −1.06790E+01 | 5.72770E+01 | −2.04010E+02 |
| R6 | −2.29223E−01 | −8.20310E−02 | 1.18240E+00 | −1.15390E+01 | 7.75010E+01 | −3.45160E+02 |
| R7 | −6.64738E+03 | 1.50880E−01 | −3.97370E+00 | 3.08350E+01 | −1.45900E+02 | 4.51710E+02 |
| R8 | 4.68163E+03 | 1.18370E−01 | −2.59290E+00 | 1.68700E+01 | −6.91520E+01 | 1.92410E+02 |
| R9 | 6.04567E+02 | −3.46420E−02 | −3.58270E−02 | 1.60940E−01 | −3.64770E−01 | 5.01840E−01 |
| R10 | −5.47751E+01 | −5.66080E−02 | −2.89590E−02 | 1.75240E−01 | −3.17620E−01 | 3.37020E−01 |
| R11 | 8.09177E−02 | −8.00980E−02 | 1.60990E−02 | 1.73100E−01 | −2.91750E−01 | 2.49900E−01 |
| R12 | −3.70144E+01 | −5.75830E−02 | 2.91110E−02 | 2.65500E−02 | −5.40310E−02 | 4.49440E−02 |

| | Conic Coefficient | Aspheric Coefficient | | | | |
|---|---|---|---|---|---|---|
| | k | A14 | A16 | A18 | A20 | A22 |
| R1 | −3.49825E−01 | 1.66580E−03 | −3.95190E−04 | 5.44830E−05 | −3.31030E−06 | 0.00000E+00 |
| R2 | −4.97991E+01 | −1.87590E−04 | 2.49230E−04 | −5.33760E−05 | 3.90010E−06 | 0.00000E+00 |
| R3 | 2.18816E+03 | 1.26010E−01 | −4.28240E−02 | 8.20480E−03 | −6.76780E−04 | 0.00000E+00 |
| R4 | 1.27536E+01 | 5.93430E−01 | −1.07690E−01 | −5.92720E−02 | 3.61780E−02 | −5.84290E−03 |
| R5 | −4.00011E+00 | 5.00660E+02 | −8.69190E+02 | 1.08350E+03 | −9.73210E+02 | 6.24440E+02 |
| R6 | −2.29223E−01 | 1.04560E+03 | −2.21130E+03 | 3.31890E+03 | −3.55380E+03 | 2.69450E+03 |
| R7 | −6.64738E+03 | −9.45090E+02 | 1.33870E+03 | −1.23190E+03 | 6.21930E+02 | −6.21200E−01 |
| R8 | 4.68163E+03 | −3.78890E+02 | 5.40570E+02 | −5.64700E+02 | 4.31760E+02 | −2.38690E+02 |
| R9 | 6.04567E+02 | −4.64750E−01 | 3.00610E−01 | −1.38070E−01 | 4.52340E−02 | −1.04940E−02 |
| R10 | −5.47751E+01 | −2.40720E−01 | 1.20840E−01 | −4.31390E−02 | 1.08960E−02 | −1.91130E−03 |
| R11 | 8.09177E−02 | −1.36120E−01 | 5.09620E−02 | −1.36940E−02 | 2.71210E−03 | −4.00870E−04 |
| R12 | −3.70144E+01 | −2.46160E−02 | 1.01310E−02 | −3.27760E−03 | 8.24130E−04 | −1.54630E−04 |

| | Conic Coefficient | Aspheric Coefficient | | | |
|---|---|---|---|---|---|
| | k | A24 | A26 | A28 | A30 |
| R1 | −3.49825E−01 | 0.00000E+00 | 0.00000E+00 | 0.00000E+00 | 0.00000E+00 |
| R2 | −4.97991E+01 | 0.00000E+00 | 0.00000E+00 | 0.00000E+00 | 0.00000E+00 |
| R3 | 2.18816E+03 | 0.00000E+00 | 0.00000E+00 | 0.00000E+00 | 0.00000E+00 |
| R4 | 1.27536E+01 | 0.00000E+00 | 0.00000E+00 | 0.00000E+00 | 0.00000E+00 |
| R5 | −4.00011E+00 | −2.79130E+02 | 8.25700E+01 | −1.45260E+01 | 1.15040E+00 |
| R6 | −2.29223E−01 | −1.41200E+03 | 4.85890E+02 | −9.86600E+01 | 8.94330E+00 |
| R7 | −6.64738E+03 | −2.32000E+02 | 1.58800E+02 | −4.87560E+01 | 6.01950E+00 |
| R8 | 4.68163E+03 | 9.28030E+01 | −2.40550E+01 | 3.73040E+00 | −2.61750E−01 |
| R9 | 6.04567E+02 | 1.68480E−03 | −1.78210E−04 | 1.11930E−05 | −3.15890E−07 |
| R10 | −5.47751E+01 | 2.24430E−04 | −1.64720E−05 | 6.60200E−07 | −9.97590E−09 |
| R11 | 8.09177E−02 | 4.38000E−05 | −3.37580E−06 | 1.64700E−07 | −4.20210E−09 |
| R12 | −3.70144E+01 | 2.05430E−05 | −1.80540E−06 | 9.35190E−08 | −2.15140E−09 |

Table 23 and Table 24 show design data of inflection points and arrest points of each lens in the camera optical lens 60 according to Comparative Embodiment.

TABLE 23

| | Number of Inflection | Inflection Point | Inflection Point |
|---|---|---|---|
| | Points | Position 1 | Position 2 |
| P1R1 | 1 | 1.825 | / |
| P1R2 | 1 | 0.745 | / |
| P2R1 | 2 | 0.315 | 1.585 |
| P2R2 | 2 | 1.315 | 1.385 |
| P3R1 | 1 | 1.205 | / |
| P3R2 | 1 | 1.175 | / |
| P4R1 | 1 | 1.185 | / |
| P4R2 | 1 | 1.265 | / |
| P5R1 | 2 | 0.225 | 1.675 |
| P5R2 | 1 | 1.815 | / |
| P6R1 | / | / | / |
| P6R2 | 1 | 2.265 | / |

TABLE 24

| | Number of Arrest | Arrest Point | Arrest Point |
|---|---|---|---|
| | Points | Position 1 | Position 2 |
| P1R1 | / | / | / |
| P1R2 | / | / | / |
| P2R1 | 1 | 0.465 | / |
| P2R2 | / | / | / |
| P3R1 | 1 | 1.315 | / |
| P3R2 | 1 | 1.215 | / |
| P4R1 | 1 | 1.215 | / |
| P4R2 | / | / | / |
| P5R1 | 2 | 0.385 | 1.795 |
| P5R2 | / | / | / |
| P6R1 | / | / | / |
| P6R2 | / | / | / |

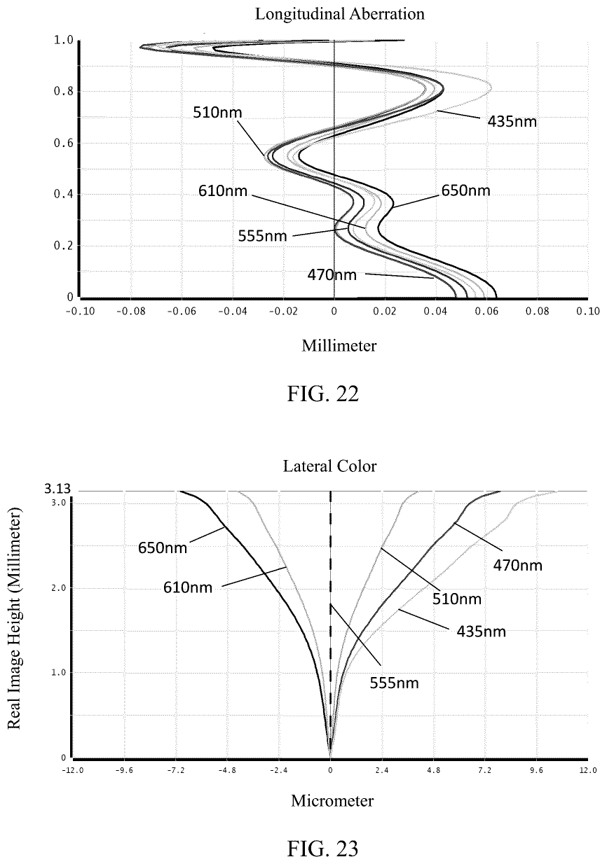

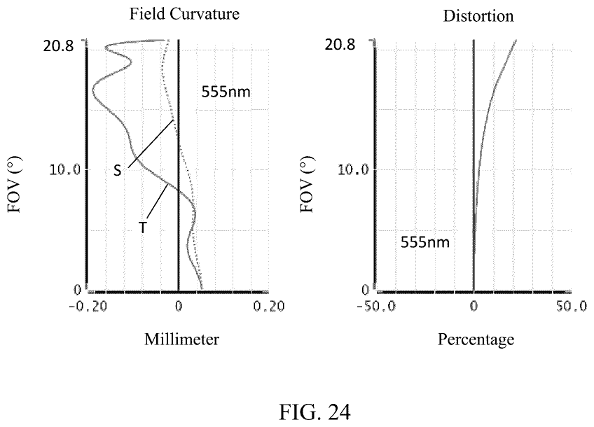

FIG. 22 and FIG. 23 respectively show longitudinal aberration and lateral color of light with wavelengths of 650 nm, 610 nm, 555 nm, 510 nm, 470 nm, and 435 nm after passing through the camera optical lens 60 according to Comparative Embodiment. FIG. 24 shows field curvature and distortion of light with a wavelength of 555 nm after passing through the camera optical lens 60 according to Comparative Embodiment. The field curvature S in FIG. 24 is the field curvature in a sagittal direction, and T is the field curvature in a meridian direction.

Table 25 below lists values corresponding to each relational expression in Comparative Embodiment according to the above relational expressions. The camera optical lens 60 of Comparative Embodiment does not satisfy the above relational expression 0.10≤d8/TTL≤0.20.

In Comparative Embodiment, the entrance pupil diameter ENPD of the camera optical lens 60 is 3.625 mm, the full field of view image height IH is 3.133 mm, and the field of view FOV in the diagonal direction is 41.50°, the camera optical lens 60 does not meet the design requirements of large-aperture and ultra-thinness.

TABLE 25

| Parameters and | | | | | | |
|---|---|---|---|---|---|---|
| Relational | | | | | | Comparative |
| Expressions | Embodiment 1 | Embodiment 2 | Embodiment 3 | Embodiment 4 | Embodiment 5 | Embodiment |
| d8/TTL | 0.149 | 0.200 | 0.103 | 0.154 | 0.154 | 0.212 |
| R9/R10 | −1.556 | −4.956 | −0.801 | −0.808 | −2.006 | −3.902 |
| f2/f3 | 0.864 | 0.700 | 0.998 | 0.786 | 0.973 | 0.848 |
| R11/R12 | 0.369 | 0.160 | 0.450 | 0.392 | 0.639 | 0.345 |
| f1/f | 0.453 | 0.489 | 0.431 | 0.500 | 0.401 | 0.464 |
| d6/d7 | 3.083 | 3.024 | 3.981 | 2.010 | 3.390 | 3.557 |
| f1 | 3.204 | 3.19 | 3.042 | 3.223 | 2.984 | 3.196 |
| f2 | −7.349 | −7.184 | −7.397 | −7.267 | −6.76 | −7.377 |
| f3 | −8.51 | −10.263 | −7.409 | −9.245 | −6.948 | −8.702 |
| f4 | −122.942 | 123.926 | −56.528 | 76.406 | −60.215 | −132.732 |
| f5 | 13.494 | 14.228 | 16.276 | 15.228 | 17.784 | 13.975 |
| f6 | −8.049 | −5.916 | −9.597 | −8.571 | −15.53 | −7.705 |
| f12 | 4.61 | 4.644 | 4.254 | 4.659 | 4.312 | 4.593 |
| FNO | 1.898 | 1.899 | 1.899 | 1.898 | 1.898 | 1.898 |
| TTL | 6.740 | 6.388 | 6.808 | 6.743 | 7.054 | 6.511 |
| IH | 3.133 | 3.133 | 3.133 | 3.133 | 3.133 | 3.133 |
| FOV | 47.57 | 50.37 | 47.65 | 47.82 | 45.72 | 41.50 |

Those skilled in the art can understand that the above embodiments are specific embodiments for implementing the present disclosure, and in practical applications, various changes may be made in form and detail without departing from the spirit and scope of the present disclosure.

What is claimed is:

1. A camera optical lens, comprising: from an object side to an image side, a first lens having positive refractive power, a second lens having negative refractive power, a third lens having negative refractive power, a fourth lens having positive or negative refractive power, and a fifth lens having positive refractive power, and a sixth lens having negative refractive power;
wherein, a focal length of the second lens is defined as f2, a focal length of the third lens is defined as f3, an on-axis distance from an image side surface of the fourth lens to an object side surface of the fifth lens is defined as d8, a central curvature radius of the object side surface of the fifth lens is defined as R9, a central curvature radius of an image side surface of the fifth lens is defined as R10, a total optical length from an object side surface of the first lens to an image plane of the camera optical lens along an optic axis of the camera optical lens is defined as TTL, and following relational expressions are satisfied:
$$0.1 ⩽ d 8 / TTL ⩽ 0.2 ; \\ - 5. ⩽ R 9 / R 10 ⩽ - 0.8 ; and \\ 0.7 ⩽ f 2 / f 3 ⩽ 1. .$$

2. The camera optical lens as described in claim 1, wherein a central curvature radius of an object side surface of the sixth lens is defined as R11, a central curvature radius of an image side surface of the sixth lens is defined as R12, and a following relational expression is satisfied:
0.16≤R11/R12≤0.64.

3. The camera optical lens as described in claim 1, wherein a focal length of the camera optical lens is defined as f, a focal length of the first lens is defined as f1, and a following relational expression is satisfied:
$$0.4 ⩽ f 1 / f ⩽ 0.5 .$$

4. The camera optical lens as described in claim 1, wherein an on-axis distance from an image side surface of the third lens to an object side surface of the fourth lens is defined as d6, an on-axis thickness of the fourth lens is defined as d7, and a following relational expression is satisfied:
$$2. ⩽ d 6 / d 7 ⩽ 4. .$$

5. The camera optical lens as described in claim 1, wherein an object side surface of the first lens is convex in a paraxial region, and an image side surface of the first lens is convex in the paraxial region;
a central curvature radius of the object side surface of the first lens is defined as R1, a central curvature radius of the image side surface of the first lens is defined as R2, an on-axis thickness of the first lens is defined as d1, and following relational expressions are satisfied:
$$- 1.25 ⩽ ( R 1 + R 2 ) / ( R 1 - R 2 ) ⩽ - 0.32 ; and \\ 0.1 ⩽ d 1 / TTL ⩽ 0.34 .$$

6. The camera optical lens as described in claim 1, wherein an object side surface of the second lens is concave in a paraxial region, and an image side surface of the second lens is concave in the paraxial region;
a focal length of the camera optical lens is defined as f, a central curvature radius of the object side surface of the second lens is defined as R3, a central curvature radius of the image side surface of the second lens is defined as R4, an on-axis thickness of the second lens is defined as d3, and following relational expressions are satisfied:
$$- 2.25 ⩽ f 2 / f ⩽ - 0.61 ; \\ 0.38 ⩽ ( R 3 + R 4 ) / ( R 3 - R 4 ) ⩽ 1.37 ; and \\ 0.01 ⩽ d 3 / TTL ⩽ 0.06 .$$

7. The camera optical lens as described in claim 1, wherein an object side surface of the third lens is convex in a paraxial region, and an image side surface of the third lens is concave in the paraxial region;
a focal length of the camera optical lens is defined as f, a central curvature radius of the object side surface of the third lens is defined as R5, a central curvature radius of the image side surface of the third lens is defined as R6, an on-axis thickness of the third lens is defined as d5, and following relational expressions are satisfied:
$$- 3.15 ⩽ f 3 / f ⩽ - 0.62 ; \\ 1.04 ⩽ ( R 5 + R 6 ) / ( R 5 - R 6 ) ⩽ 4.75 ; and \\ 0.02 ⩽ d 5 / TTL ⩽ 0.07 .$$

8. The camera optical lens as described in claim 1, wherein a focal length of the camera optical lens is f, a focal length of the fourth lens is defined as f4, a central curvature radius of the object side surface of the fourth lens is defined as R7, a central curvature radius of the image side surface of the fourth lens is defined as R8, an on-axis thickness of the fourth lens is defined as d7, and following relational expressions are satisfied:
$$- 34.78 ⩽ f 4 / f ⩽ 28.49 ; \\ - 5.49 ⩽ ( R 7 + R 8 ) / ( R 7 - R 8 ) ⩽ 1.62 ; and \\ 0.02 ⩽ d 7 / TTL ⩽ 0.07 .$$

9. The camera optical lens as described in claim 1, wherein the object side surface of the fifth lens is convex in a paraxial region, the image side surface of the fifth lens is convex in the paraxial region;
a focal length of the camera optical lens is defined as f, a focal length of the fifth lens is f5, an on-axis thickness of the fifth lens is defined as d9, and following relational expressions are satisfied:
$$0.95 ⩽ f 5 / f ⩽ 3.59 ; \\ - 0.22 ⩽ ( R 9 + R 10 ) / ( R 9 - R 10 ) ⩽ 1. ; and \\ 0.04 ⩽ d 9 / TTL ⩽ 0.15 .$$

10. The camera optical lens as described in claim 1, wherein an object side surface of the sixth lens is concave in a paraxial region, and an image side surface of the sixth lens is convex in the paraxial region;
a focal length of the camera optical lens is f, a focal length of the sixth lens is defined as f6, a central curvature radius of the object side surface of the sixth lens is defined as R11, a central curvature radius of the image side surface of the sixth lens is defined as R12, an on-axis thickness of the sixth lens is defined as d11, and following relational expressions are satisfied:
$$- 4.17 ⩽ f 6 / f ⩽ - 0.6 ; \\ - 9.09 ⩽ ( R 11 + R 12 ) / ( R 11 - R 12 ) ⩽ - 0.92 ; and \\ 0.02 ⩽ d 11 / TTL ⩽ 0.15 .$$
